(19) United States
(12) Patent Application Publication
(10) Pub. No.: US 2021/0392384 A1
(43) Pub. Date: Dec. 16, 2021

(54) DISTRIBUTION SYSTEM, INFORMATION PROCESSING SERVER, AND DISTRIBUTION METHOD

(71) Applicant: SONY GROUP CORPORATION, Tokyo (JP)

(72) Inventors: Yasuaki YAMAGISHI, Kanagawa (JP); Kazuhiko TAKABAYASHI, Tokyo (JP)

(73) Assignee: SONY GROUP CORPORATION, Tokyo (JP)

(21) Appl. No.: 17/282,927

(22) PCT Filed: Sep. 25, 2019
(86) PCT No.: PCT/JP2019/037505

§ 371 Date: Apr. 5, 2021

(30) Foreign Application Priority Data
Oct. 12, 2018 (JP) 2018-193871

(51) Int. Cl. H04N 21/2187; H04N 21/6547

(52) U.S. Cl. CPC H04N 21/2187; H04N 21/6547

(57) ABSTRACT

A distribution system (1) includes: a plurality of imaging devices (10-1, 10-2, and 10-3) having different specifications; and an information processing server (100) including a controller (120) that generates first control information on the basis of a video stream uplinked from each of a plurality of the imaging devices. The first control information indicates a maximum bit rate value of the video stream. The first control information includes information common to a plurality of the imaging devices.

### TECHNICAL FIELD

The present disclosure relates to a distribution system, an information processing server, and a distribution method.

### BACKGROUND ART

A distribution platform referred to as video ecosystem may possibly support a standard content (stream) uplink interface with an increase in use cases in which streams of UGC (User Generate Contents) content or the like are distributed (e.g., NPTL 1).

The stream uplink interface is used, for example, for a low-cost smartphone camera or video camera that captures UGC content. The stream uplink interface has to be usable even in a case where a variety of streams recorded by business-use cameras for professional use are uplinked. As mobile communication systems transition to 5G, it may be possibly popular in the future to uplink recorded streams for professional use with high quality via general mobile networks.

### CITATION LIST

### Non-Patent Literature

NPTL 1: 3rd Generation Partnership Project; Technical Specification Group Services and System Aspects; Guidelines on the Framework for Live Uplink Streaming (FLUS); (Release 15), 3GPP TR 26.939 V15.0.0 (2018-06).

### SUMMARY OF THE INVENTION

### Problems to be Solved by the Invention

Meanwhile, there is a problem that an issue with a constraint on bands is inevitable. For example, a band of 12 Gbps is necessary for a baseband stream of 4K/60 fps. To address this, a current possible technique encodes streams to lossy compressed streams and uplinks the streams. For example, it is a standard under consideration to encode streams with H.265, store the streams in the CMAF (Common Media Application Format) file format, and uplink the streams.

It is assumed here that streams used for live distribution are made from imaging devices which generate a variety of streams. The imaging devices come from different makers and have different functions. However, no common instruction method has been currently established that is recognizable to all of the imaging devices. In addition, it is preferable in such live broadcast to change maximum bit rate instructions to the respective sources for each of time sections having any time granularity to allocate a large number of bands to video (angle) that viewers and listeners seem to wish to watch the most. It is therefore desirable in the present disclosure to introduce control messages that are understandable in common to imaging devices from different vendors. The control messages are permitted to be transferred to the respective imaging devices. The control messages each indicate the maximum bit rate.

In addition, in a case where there are sufficient redundant uplink bands in live distribution, it is possible to uplink a stream of a high image quality version in parallel with normal stream distribution. In this case, it is desirable to notify a user that a high image quality version of the stream distribution that the user is currently viewing and listening to is going to be uplinked after given time passes.

In addition, in a case where there are sufficient redundant uplink bands in live distribution, it is desirable to retain a normal stream at a necessary and sufficient bit rate by allocating a maximum bit rate value desired by a user group viewing and listening to the normal stream at that time to the normal stream and allocate as many redundant bands as possible to a stream of a high image quality version.

In addition, in live distribution, a case is assumed where a stream is distributed that matches a moment-to-moment viewing and listening preference of a user viewing and listening to the live distribution. In this case, it is desirable to introduce a control message. The control message is understandable in common to imaging devices from different vendors. The control message indicates the viewing and listening preference of the user.

Accordingly, the present disclosure proposes a distribution system, an information processing server, and a distribution method that each make it possible to efficiently control the bit rates of video streams uplinked from a plurality of cameras.

### Means for Solving the Problems

To solve the above-described problem, a distribution system according to an embodiment of the present disclosure includes: a plurality of imaging devices having different specifications; and an information processing server including a controller that generates first control information on the basis of a video stream uplinked from each of a plurality of the imaging devices. The first control information indicates a maximum bit rate value of the video stream. The first control information includes information common to a plurality of the imaging devices.

In addition, in a case where an uplink communication band is predicted to have a redundant band a predetermined period after the video stream is uplinked, the controller may generate second control information indicating that it is going to be possible to view and listen to a high image quality version of the video stream after the predetermined period passes.

In addition, the controller may generate third control information for each of a plurality of the imaging devices. The third control information indicates a maximum bit rate value of the video stream corresponding to a request from a user.

In addition, the controller may extract video data from a plurality of the video streams and generate fourth control information. The video data corresponds to taste of a user. The fourth control information causes a terminal of the user to explicitly indicate the extracted video data.

### BRIEF DESCRIPTION OF DRAWING

FIG. 1 is a schematic diagram illustrating an example of a configuration of a distribution system according to the present disclosure.

FIG. 2 is a block diagram illustrating an example of a configuration of a relay node that is disposed downstream of the distribution system according to the present disclosure.

FIG. 3 is a block diagram illustrating an example of an overall configuration of the distribution system according to the present disclosure.

FIG. 4 is a diagram for describing a video stream that is uplinked from an imaging device.

FIG. 5 is a sequence diagram illustrating an example of processing for configuring a multicast tree in the distribution system according to the present disclosure.

FIG. 6 is a sequence diagram illustrating an example of a processing flow of a distribution system according to a first embodiment.

FIG. 7A is a diagram illustrating an example of an MPD (Media Presentation Description) file according to the first embodiment.

FIG. 7B is a diagram illustrating an example of MPD according to the first embodiment.

FIG. 7C is a diagram illustrating an example of the MPD according to the first embodiment.

FIG. 8 is a diagram illustrating an example of the MPD according to the first embodiment.

FIG. 9 is a diagram illustrating an example of the MPD according to the first embodiment.

FIG. 10A is a diagram illustrating an example of the MPD according to the first embodiment.

FIG. 10B is a diagram illustrating an example of the MPD according to the first embodiment.

FIG. 10C is a diagram illustrating an example of the MPD according to the first embodiment.

FIG. 11 is a diagram illustrating an example of the MPD according to the first embodiment.

FIG. 12 is a diagram illustrating an example of the MPD according to the first embodiment.

FIG. 13 is a sequence diagram illustrating an example of a processing flow between a source unit and a sink unit in the distribution system according to the first embodiment.

FIG. 14 is a sequence diagram illustrating an example of the processing flow between the source unit and the sink unit in the distribution system according to the first embodiment.

FIG. 15 is a diagram illustrating an example of ServiceResource according to the first embodiment.

FIG. 16 is a diagram illustrating an example of SessionResource according to the first embodiment.

FIG. 17 is a diagram illustrating an example of SDP (Session Description Protocol) used in the distribution system according to the first embodiment.

FIG. 18 is a diagram illustrating an example of SessionResource according to the first embodiment.

FIG. 19 is a diagram for describing a video stream that is uplinked in each of time sections.

FIG. 20 is a diagram illustrating an example of MPD.

FIG. 21 is a diagram illustrating an example of MPD.

FIG. 22 is a schematic diagram for describing a redundant band.

FIG. 23 is a schematic diagram illustrating a configuration of a distribution system according to a second embodiment.

FIG. 24 is a diagram illustrating an example of MPD according to the second embodiment.

FIG. 25 is a diagram illustrating an example of the MPD according to the second embodiment.

FIG. 26 is a diagram illustrating an example of the MPD according to the second embodiment.

FIG. 27 is a diagram illustrating an example of the MPD according to the second embodiment.

FIG. 28 is a diagram illustrating an example of the MPD according to the second embodiment.

FIG. 29 is a diagram illustrating an example of the MPD according to the second embodiment.

FIG. 30 is a diagram for describing an operation of the distribution system according to the second embodiment.

FIG. 31 is a sequence diagram illustrating an example of a processing flow of the distribution system according to the second embodiment.

FIG. 32 is a sequence diagram illustrating an example of the processing flow of the distribution system according to the second embodiment.

FIG. 33 is a schematic diagram illustrating a configuration of a distribution system according to a third embodiment.

FIG. 34 is a sequence diagram illustrating an example of a processing flow of the distribution system according to the third embodiment.

FIG. 35 is a sequence diagram illustrating an example of the processing flow of the distribution system according to the third embodiment.

FIG. 36 is a sequence diagram illustrating an example of a processing flow between a source unit and a sink unit in the distribution system according to the third embodiment.

FIG. 37 is a diagram illustrating an example of SessionResource according to the third embodiment.

FIG. 38 is a sequence diagram illustrating an example of a processing flow between and edge processing unit and a route processing unit in the distribution system according to the third embodiment.

FIG. 39 is a diagram illustrating an example of SessionResource according to the third embodiment.

FIG. 40 is a schematic diagram illustrating a configuration of a distribution system according to a fourth embodiment.

FIG. 41A is a diagram for describing an operation of the distribution system according to the fourth embodiment.

FIG. 41B is a diagram for describing the operation of the distribution system according to the fourth embodiment.

FIG. 41C is a diagram for describing the operation of the distribution system according to the fourth embodiment.

FIG. 42 is a sequence diagram illustrating an example of a processing flow of the distribution system according to the fourth embodiment.

FIG. 43 is a sequence diagram illustrating an example of the processing flow of the distribution system according to the fourth embodiment.

FIG. 44 is a diagram illustrating an example of MPD according to the fourth embodiment.

FIG. 45 is a diagram illustrating an example of the MPD according to the fourth embodiment.

FIG. 46 is a diagram illustrating an example of the MPD according to the fourth embodiment.

FIG. 47 is a sequence diagram illustrating an example of a processing flow between and edge processing unit and a route processing unit in the distribution system according to the fourth embodiment.

FIG. 48 is a diagram illustrating an example of SessionResource according to the fourth embodiment.

FIG. 49 is a hardware configuration diagram illustrating an example of a computer that achieves a function of the distribution system.

### MODES FOR CARRYING OUT THE INVENTION

The following describes embodiments of the present disclosure in detail with reference to the drawings. It is to be noted that the same signs are assigned to the same components in the following respective embodiments, thereby omitting repeated description.

In addition, the present disclosure is described in the following order of items.

1. First Embodiment

2. Second Embodiment

3. Third Embodiment

4. Fourth Embodiment

5. Hardware Configuration

### 1. First Embodiment

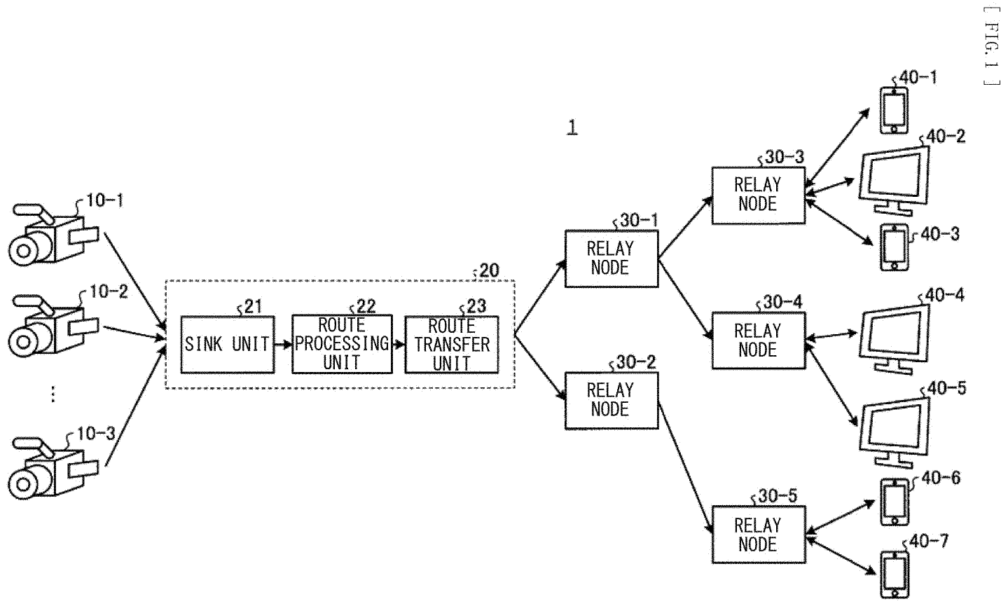

An overview of a configuration of a distribution system according to a first embodiment of the present disclosure is described with reference to FIG. 1. FIG. 1 is a schematic diagram illustrating the configuration of the distribution system according to the first embodiment of the present disclosure.

As illustrated in FIG. 1, a distribution system 1 includes imaging devices 10-1 to 10-N (N is an integer of 3 or more), a distribution device 20, relay nodes 30-1 to 30-5, and user terminals 40-1 to 40-7. In the present embodiment, the distribution system 1 is a multicast distribution system that has a multicast tree including the relay nodes 30-1 to 30-5. It is to be noted that the number of relay nodes and the number of user terminals included in the distribution system 1 do not limit the present disclosure.

Each of the imaging devices 10-1 to 10-N uplinks, for example, captured video data to the distribution device 20 via a communication network that is not illustrated. Specifically, the imaging devices 10-1 to 10-N are installed, for example, in the same place or the same venue. The imaging devices 10-1 to 10-N uplink images of landscapes, sporting games, and the like shot by the respective imaging devices 10-1 to 10-N to the distribution device 20. For example, the respective imaging devices 10-1 to 10N come from different vendors and have different grades.

The distribution device 20 transmits, for example, video streams uplinked from the imaging devices 10-1 to 10-N to the user terminals 40-1 to 40-7 via the relay nodes 30-1 to 30-5. Specifically, the distribution device 20 includes, for example, a sink unit 21, a route processing unit 22, and a route transfer unit 23. In this case, a video stream is transmitted from the distribution device 20 via the sink unit 21, the route processing unit 22, and the route transfer unit 23. It is to be noted that the sink unit 21, the route processing unit 22, and the route transfer unit 23 are described below.

The relay node 30-1 to the relay node 30-5 are relay stations that are disposed between the distribution device 20 and the user terminals 40-1 to 40-7.

The relay node 30-1 and the relay node 30-2 are, for example, upstream relay nodes. The relay node 30-1 and the relay node 30-2 each receives a video stream outputted from the distribution device 20. In this case, the relay node 30-1 distributes video streams received from the distribution device 20 to the relay node 30-3 and the relay node 30-4. In addition, the relay node 30-2 distributes a video stream received from the distribution device 20 to the relay node 30-5.

The relay nodes 30-3 to 30-5 are, for example, downstream relay nodes. The relay nodes 30-3 to 30-5 distribute video streams received from the upstream relay nodes to viewing and listening terminal devices owned by respective users. Specifically, the relay node 30-3 performs predetermined processing on video streams and transmits the video streams to the user terminals 40-1 to 40-3. The relay node 30-4 performs predetermined processing on video streams and transmits the video streams to the user terminals 40-4 and 40-5. The relay node 30-5 performs predetermined processing on video streams and transmits the video streams to the user terminals 40-6 and 40-7.

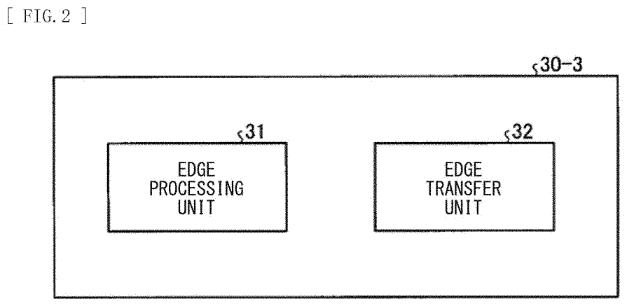

FIG. 2 is a block diagram illustrating a configuration of the relay node 30-3 that is a downstream relay node. As illustrated in FIG. 2, the relay node 30-3 includes an edge processing unit 31 and an edge transfer unit 32. The relay nodes 30-4 and 30-5 each have a configuration similar to that of the relay node 30-3. Although specifically described below, the edge processing unit 31 controls the bit rate of a video stream in accordance with the performance of a user terminal to which the video stream is transmitted.

The user terminals 40-1 to 40-N are terminals owned by respective users for viewing and listening to video streams. There are a variety of terminals for viewing and listening to video streams. Each of the user terminals 40-1, 40-3, 40-6, and 40-7 is, for example, a smartphone. Each of the user terminals 40-2, 40-4, and 40-5 is, for example, a computer. The user terminals 40-1 to 40-N are thus usually different in performance.

It is assumed that the distribution system 1 is used for live broadcasting services with limited operational cost. In this case, QoS (Quality of Service) necessary for transfer sessions that is generally necessary has to, however, include ultra-low delay, a minimum error rate, and the like. To guarantee that, high cost is requested. To keep this cost constant, the total band for live capture streams has to remain constant or refrain from exceeding a certain value. In addition, it is assumed that streams used for live broadcast are made from imaging device modules (sources) which generate a variety of streams. The imaging device modules (sources) come from different makers and have different functions. Therefore, a possible technique of keeping the total band for video streams simultaneously transmitted from imaging devices within constant bandwidth from the perspective of cost includes a technique of making an adjustment to keep the source streams of the respective imaging devices within a constant total band by issuing instructions about bit rates from the sink (distribution device 20) side. The imaging devices come from a plurality of makers. The imaging devices have a plurality of various grades.

However, currently, there is no common method of instructing all of the imaging devices from the sink (distribution device 20) side, which is recognizable to all of the imaging devices, in the above-described case. To achieve this, all of the imaging devices having a variety of grades have to be uniformly obtained from the same vendor. The cost thereof raises an issue. In addition, an uplink protocol has to be implemented between each of imaging devices and the distribution device 200 to allow the imaging device to be adjusted within a bit rate permitted to the imaging device. This raises an issue that it is highly likely to fail in satisfying the fundamental requirement “general users bring imaging devices that come from different vendors and have a variety of grades”.

In addition, it is preferable to change maximum bit rate instructions to the respective sources for each of time sections having any time granularity to allocate a large number of bands to video (angle) that viewers and listeners seem to wish to watch the most. Further, it is preferable that allocated bands be seamlessly switchable (in the above-described time interval granularity) between those streams to cover diverse preferences of viewers and listeners. This requests a system clock synchronization protocol such as NTP (Network Time Protocol) to be implemented for synchronizing system clocks and requests control that is implementable in common in imaging devices which come from different vendors and have a variety of grades. For example, a standard streaming protocol is requested that unifies Uplink methods of streams into a DASH streaming protocol and performs control such as sharing a common codec initialization parameter as designated in an initialize segment (Initialize Segment) of MPD.

The present disclosure then newly introduces control messages indicating maximum bit rates. The control messages are understandable in common to imaging devices coming from different vendors, that is, imaging devices having different specifications. The control messages are permitted to be transferred to the respective imaging devices. A segment having any segment length is notified of the maximum uplink bit rate value that reflects the intention of a producer in a streaming control module implemented in each of the imaging devices. A system clock synchronization protocol such as NTP or PTP (Picture Transfer Protocol) is implemented in the streaming control module of each of the imaging devices. The imaging devices share the same wall clock. Further, a distribution system is proposed that is able to designate maximum bit rate instructions to a plurality of sources in any time section (integer multiple of segment lengths unified into the same certain time over all of the sources) with management metadata such as SDP or MPD.

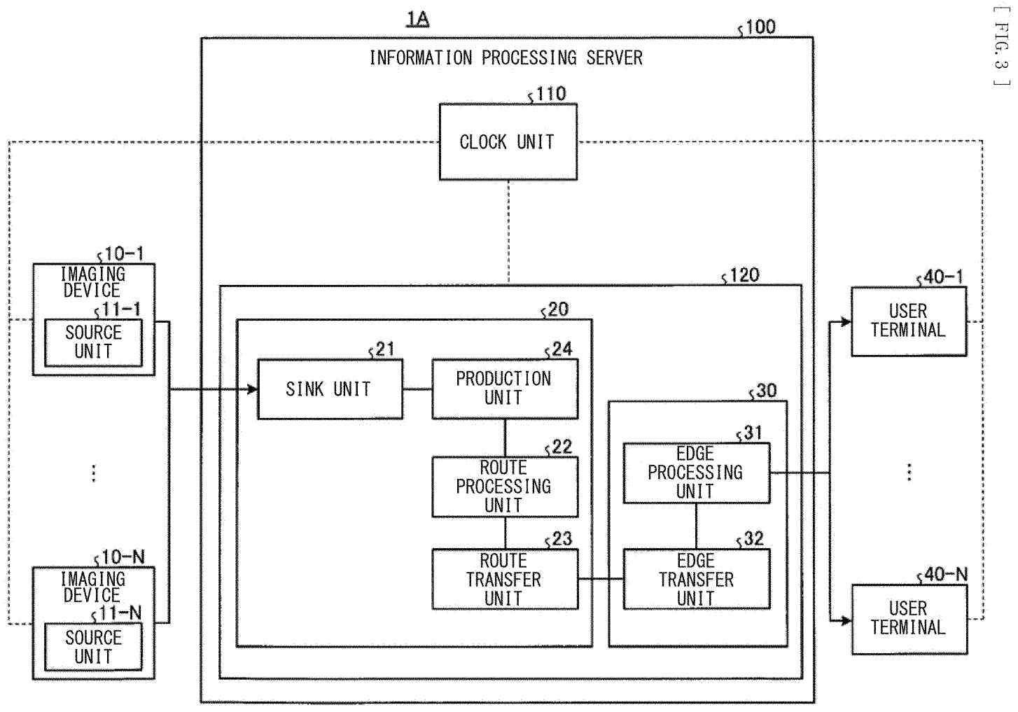

With reference to FIG. 3, a configuration of a distribution system 1A according to the present disclosure is described. FIG. 3 is a block diagram illustrating an overall configuration of the distribution system 1A according to the present disclosure.

As illustrated in FIG. 3, the distribution system 1A includes the imaging devices 10-1 to 10-N, the user terminals 40-1 to 40-N, and an information processing server 100.

The imaging device 10-1 to the imaging device 10-N are sources of video streams. The imaging device 10-1 to the imaging device 10-N are coupled to the information processing server 100 via a network that is not illustrated. The imaging device 10-1 to the imaging device 10-N respectively include source units 11-1 to 11-N for establishing streaming sessions with the information processing server 100. In a case where there is no need to particularly distinguish the source units 11-1 to 11-N, the following sometimes refers to the source units 11-1 to 11-N generically as source unit 11. In the present disclosure, the source units 11-1 to 11-N are, for example, FLUS (Framework for Live Uplink Streaming) sources. For example, the use of FLUS makes it possible to achieve live media streaming between the imaging devices 10-1 to 10-N and the information processing server 100 in the present disclosure. Therefore, the following sometimes refers a source unit simply as FLUS source.

The information processing server 100 includes a clock unit 110 and a controller 120. The information processing server 100 is a server device disposed on the cloud. It is described that the one information processing server 100 achieves the distribution device 20 and a relay node 30 in the distribution system 1A, but this is an example. This does not limit the present disclosure. The information processing server 100 may include a plurality of servers.

The clock unit 110 outputs synchronization signals, for example, to the imaging devices 10-1 to 10-N, the user terminals 40-1 to 40-N, and the controller 120. This synchronizes the system clocks between the imaging devices 10-1 to 10-N, the user terminals 40-1 to 40-N, and the controller 120. The synchronization signals include, for example, NTP, PTP, or the like.

The controller 120 controls the respective units included in the information processing server 100. It is possible to achieve the controller 120, for example, by using an electronic circuit including CPU (Central Processing Unit). The controller 120 has functions of the distribution device 20 and the relay node 30. The controller 120 includes the sink unit 21, the route processing unit 22, the route transfer unit 23, a production unit 24, the edge processing unit 31, and the edge transfer unit 32. In this case, the relay node 30 is a downstream relay node that distributes video streams to the user terminals 40-1 to 40-N.

The sink unit 21 establishes sessions for executing live media streaming, for example, with the source units 11-1 to 11-N. In the present disclosure, the sink unit 21 is, for example, a FLUS sink. Therefore, the following sometimes refers the sink unit 21 simply as FLUS sink. This makes it possible to establish FLUS sessions between the source units 11-1 to 11-N and the sink unit 21. The FLUS sink is specifically described below. The FLUS sink newly introduces FLUS-MaxBitrate to a FLUS message as a message indicating a maximum bit rate. The message is understandable in common to imaging devices coming from different vendors and permitted to be transferred. The FLUS sink then notifies the individual imaging devices of the maximum uplink bit rate values.

The route processing unit 22 performs packaging for format conversion, for example, on video streams received by the sink unit 21. The route processing unit 22 may, for example, re-encode, segment, or encrypt video streams.

The route transfer unit 23 performs multicast or unicast transfer, for example, for the relay node 30. In a case where the route transfer unit 23 performs multicast, a multicast tree is formed between the route transfer unit 23 and the edge transfer unit 32.

The production unit 24 notifies the imaging devices 10-1 to 10-N, for example, of information regarding the permitted maximum bit rate values of video streams to the imaging devices 10-1 to 10-N. Here, the production unit 24 determines the maximum bit rate value permitted to each of the imaging devices, for example, on the basis of information regarding an interest of a user viewing and listening to a video stream. A method for the production unit 24 to notify the imaging devices 10-1 to 10-N of information regarding the maximum bit rate values permitted to the respective imaging devices is described below.

The edge processing unit 31 packages video streams again for the user terminals 40-1 to 40-N to distribute the optimum video streams for the conditions of the respective user terminals. In this case, the edge processing unit 31 may, for example, re-encode, segment, or encrypt video streams. The edge processing unit 31 outputs the video streams that have been packaged again to the user terminals 40-1 to 40-N. In a case where there is no need to particularly distinguish the user terminals 40-1 to 40-N, the following sometimes refers to the user terminals 40-1 to 40-N generically as user terminal 40.

The edge transfer unit 32 receives the video streams processed by the route processing unit 22 from the route transfer unit 23. The edge transfer unit 32 outputs the video streams received from the route transfer unit 23 to the edge processing unit 31.

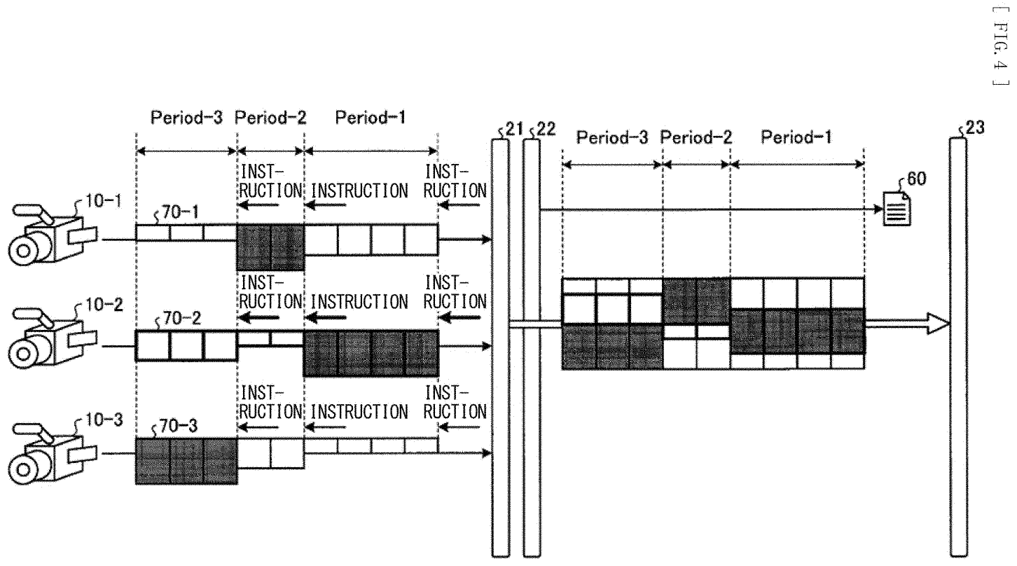

Next, with reference to FIG. 4, a video stream uplinked from an imaging device is described. FIG. 4 is a schematic diagram for describing a video stream that is uplinked from an imaging device.

The following describes that video streams are uplinked from the three imaging devices of the imaging devices 10-1 to 10-3, but this is an example. This does not limit the present disclosure.

As illustrated in FIG. 4, each of the imaging devices 10-1 to 10-3 divides a video stream into any segments and transmits the video stream to the sink unit 21. Specifically, the imaging device 10-1 transmits a video stream divided into a plurality of segments 70-1 to the sink unit 21. The imaging device 10-2 transmits a video stream divided into a plurality of segments 70-2 to the sink unit 21. The imaging device 10-3 transmits a video stream divided into a plurality of segments 70-3 to the sink unit 21. It is to be noted that the horizontal axis indicates time length and the vertical axis indicates a permitted maximum bit rate in each of the segments 70-1 to 70-3.

In the present disclosure, the segments 70-1 to 70-3 have, for example, the same time length. This makes it possible in the present disclosure to control a bit rate permitted to each of the imaging devices at any time intervals. Specifically, it is possible to control bit rates permitted to each of the imaging devices at time intervals common to the respective imaging device. The time intervals each correspond to an integer multiple of the time length of the segment.

For example, time intervals for four segments are set in “Period-1” in accordance with an instruction from the information processing server 100. Time intervals for two segments are set in “Period-2” in accordance with an instruction from the information processing server 100. Time intervals for three segments are set in “Period-3” in accordance with an instruction from the information processing server 100. It is possible in the present disclosure to control the maximum bit rate values permitted to each of imaging devices at the respective time intervals. It is then possible in the present disclosure to set a higher bit rate value for a video stream in which a user seems to be more interested.

In “Period-1”, the maximum bit rate value permitted to the imaging device 10-2 is set to be the highest and the maximum bit rate value permitted to the imaging device 10-3 is set to be the lowest.

In “Period-2”, the maximum bit rate value permitted to the imaging device 10-1 is set to be the highest and the maximum bit rate value permitted to the imaging device 10-2 is set to be the lowest.

In “Period-3”, the maximum bit rate value permitted to the imaging device 10-3 is set to be the highest and the maximum bit rate value permitted to the imaging device 10-1 is the lowest.

It is possible in the present disclosure to optionally change the maximum bit rate value permitted to each of imaging devices at any time intervals on the information processing server 100 side. In this case, in a case where the respective imaging devices 10-1 to 10-3 are shooting, for example, images of a sporting game, the maximum bit rate value permitted to an imaging device that is shooting an image of a popular player is set to be high. In other words, it is possible to increase, on the information processing server 100 side, the maximum bit rate value permitted to an imaging device that is shooting video (ROI: Region Of Interest) that is desired to be provided to a user because the user seems to be interested in the video.

As illustrated in FIG. 4, the route processing unit 22 packages video streams outputted from the respective imaging devices into one and outputs the packaged video stream to the route transfer unit 23. In addition, the route processing unit 22 generates MPD as metadata of a video stream in streaming that uses MPEG-DASH. The MPD has a hierarchical structure with “Priod”, “AdaptationSet”, “Representation”, “Segment Info”, “Initialization Segment”, and “Media Segment”. Although specifically described below, MPD is associated with information regarding ROI in the present disclosure.

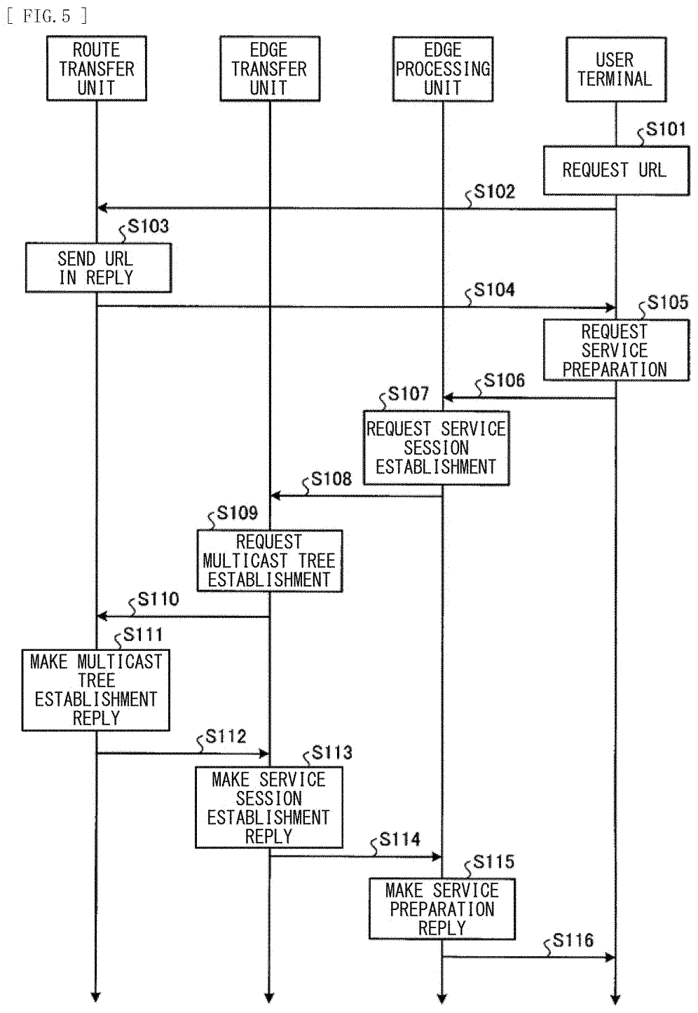

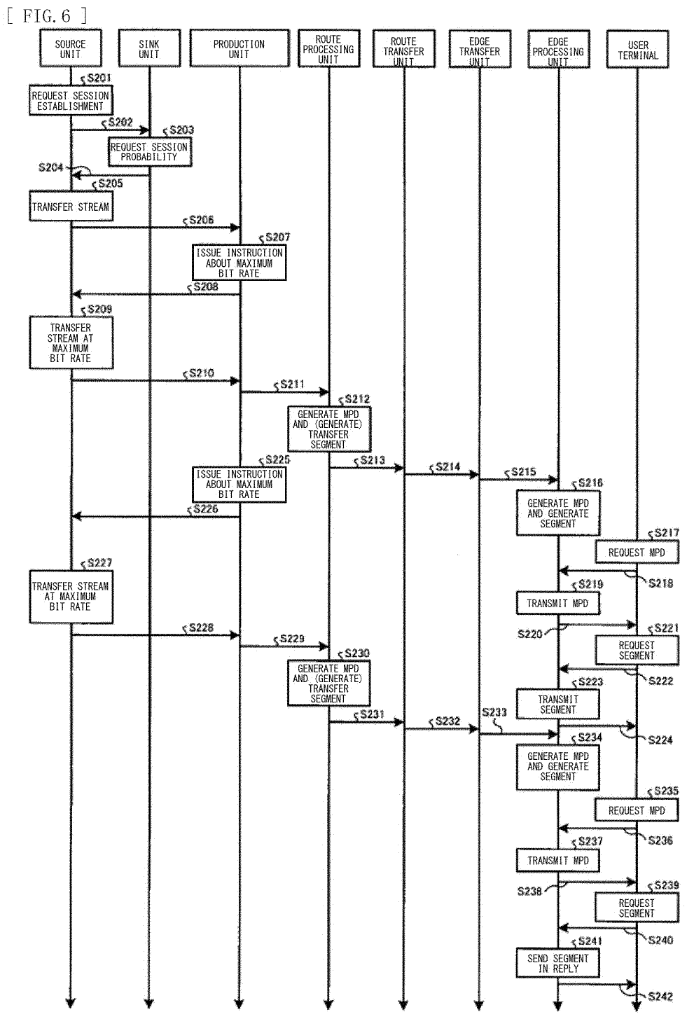

With reference to FIGS. 5 and 6, an operation of the distribution system 1A is described. Each of FIGS. 5 and 6 is a sequence diagram for describing an operation of the distribution system 1A.

FIG. 5 is a sequence diagram illustrating an example of a processing flow for establishing a multicast tree in the distribution system 1A.

First, a user terminal 40 requests, for example, desired URL (Uniform Resource Locator) for viewing and listening to a moving image from the route transfer unit 23 (step S101 and step S102). The route transfer unit 23 sends the requested URL to the user terminal 40 in reply (step S103 and step S104).

Next, the user terminal 40 requests the edge processing unit 31 to prepare, for example, a service for viewing and listening to video streaming (step S105 and step S106). Upon receiving the request, the edge processing unit 31 requests the edge transfer unit 32 to establish a session for the service (step S107 and step S108).

Upon receiving the request, the edge transfer unit 32 requests the route transfer unit 23 to establish a multicast tree (step S109 and step S110). Upon receiving the request, the route transfer unit 23 establishes a multicast tree and replies to the edge transfer unit 32 (step S111 and step S112).

Upon receiving the reply, the edge transfer unit 32 then replies to the edge processing unit 31 that a service session has been established (step S113 and step S114). Upon receiving the reply, the edge processing unit 31 notifies the user terminal 40 that a service for viewing and listening to a video stream has been prepared. This forms a multicast tree in the distribution system 1A.

FIG. 6 is a sequence diagram illustrating an example of a processing flow of the distribution system 1A. It is to be noted that description is given by assuming that a multicast tree has already been established in the distribution system 1A in FIG. 5.

The source unit 11 requests the sink unit 21 to establish a FLUS session (step S201 and step S202). Upon receiving the request, the sink unit 21 replies to the source unit 11 that a FLUS session has been established. This establishes a FLUS session between the source unit 11 and the sink unit 21. It is to be noted that a detailed method of establishing a session between the source unit 11 and the sink unit 21 is described below.

Next, the source unit 11 transfers a video stream to the production unit 24 (step S205 and step S206). Here, the source unit 11 is notified of MPD generated by the sink unit 21. The source unit 11 generates segments on the basis of the bit rate value described in the MPD of which the source unit 11 is notified. The source unit 11 notifies the production unit 24 of the segments. Here, the sink unit 21 is able to unify mapping into wall clock axes of the time intervals of the individual segments. This makes it possible to seamlessly switch the video streams transferred from the plurality of source units. It is to be noted that the bit rate value that the sink unit 21 notifies the source unit 11 of and is described in the MPD is a recommended value. The bit rate value of the video stream transferred in step S205 and step S206 may be freely set by the source unit 11.

Next, the production unit 24 instructs the source unit 11 about the permitted maximum bit rate value (step S207 and step S208). Here, the production unit 24 generates MPD in which the permitted maximum value of bit rate values is described and transmits the MPD to the source unit 11. In addition, the production unit 24 also transmits a FLUS-Max-Bitrate message (see FIG. 18) to the source unit 11 along with the MPD. The FLUS-Max-Bitrate message is described below.

Next, the source unit 11 transfers a video stream to the production unit 24 at the permitted maximum bit rate value (step S209 and step S210). Here, MPD corresponding to the transferred video stream is generated by the production unit 24.

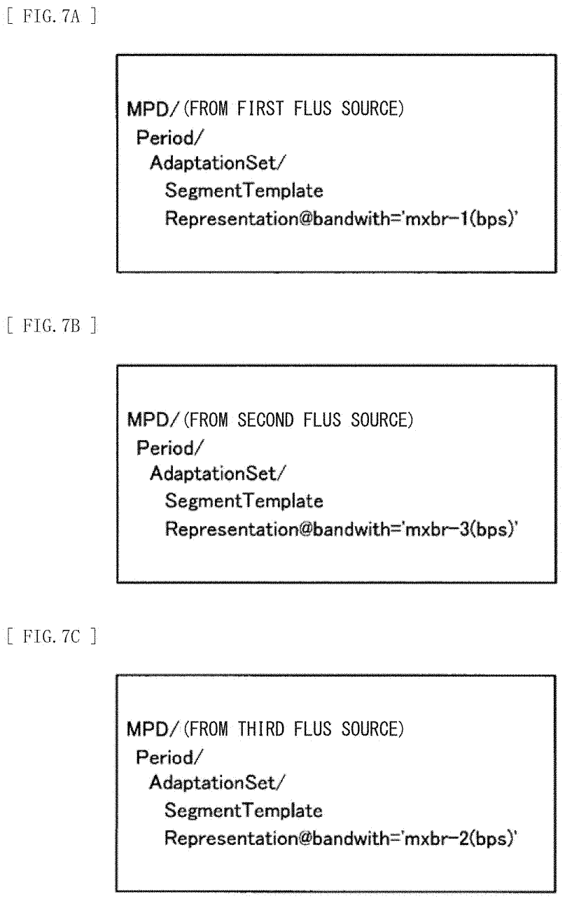

Each of FIGS. 7A, 7B, and 7C is a diagram illustrating an example of MPD generated by the production unit 24. Here, a case is described in which video streams are received from three FLUS sources as the source units 11.

FIG. 7A illustrates MPD generated by the production unit 24. The MPD corresponds to a video stream transferred from a first FLUS source. As illustrated in FIG. 7A, the maximum bit rate value permitted to the first FLUS source is described in “Representation” of “AdaptationSet” like “@bandwith=‘mxbr-1(bps)’”. FIG. 7B illustrates MPD generated by the production unit 24. The MPD corresponds to a video stream transferred from a second FLUS source. As illustrated in FIG. 7B, the maximum bit rate value permitted to the second FLUS source is described in “Representation” of “AdaptationSet” like “@bandwith=‘mxbr-3(bps)’”. FIG. 7C illustrates MPD generated by the production unit 24. The MPD corresponds to a video stream transferred from a third FLUS source. As illustrated in FIG. 7C, the maximum bit rate value permitted to the third FLUS source is described in “Representation” of “AdaptationSet” like “@bandwith=‘mxbr-2(bps)’”. In other words, FIGS. 7A to 7C illustrate that the maximum bit rate value permitted to the second FLUS source is the largest and the maximum bit rate value permitted to the first FLUS source is the smallest.

The production unit 24 outputs each of the three generated MPDs to the route processing unit 22 (step S211). The route processing unit 22 newly generates MPD on the basis of the three MPDs and generates the segments described in the newly generated MPD (step S212). Here, in a case where MPD and a segment are exchanged between the source unit 11 and the sink unit 21, the route processing unit 22 transfers the segment. In a case where MPD and a segment are not exchanged between the source unit 11 and the sink unit 21, the route processing unit 22 generates any segment in step S212.

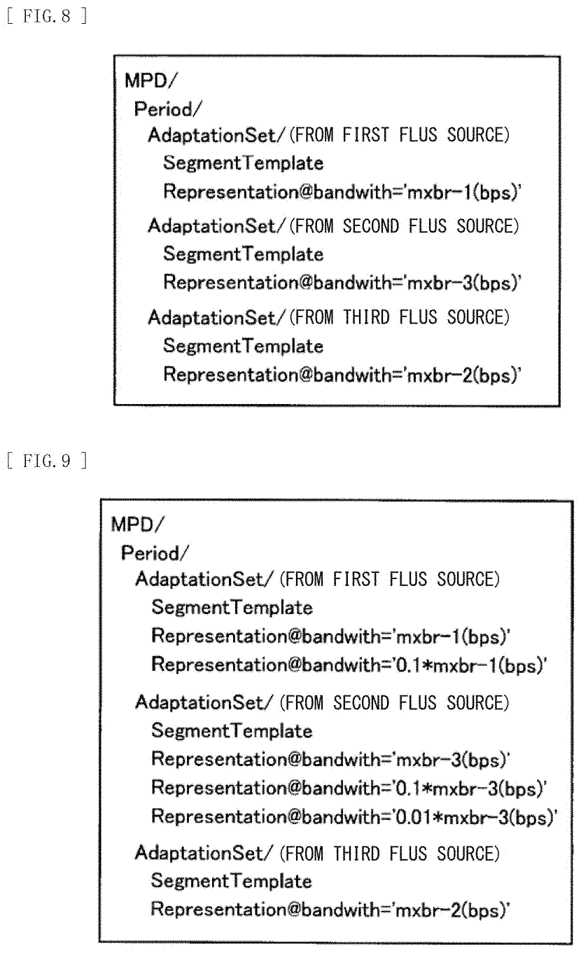

FIG. 8 is a diagram illustrating an example of MPD generated by the route processing unit 22 in step S212. As illustrated in FIG. 8, the route processing unit 22 puts together the three MPDs received from the production unit 24 and generates one MPD.

The route processing unit 22 transmits the generated MPD and segment to the route transfer unit 23 (step S213). The route transfer unit 23 transfers the MPD and the segment to the edge transfer unit 32 (step S214). The edge transfer unit 32 transmits the MPD and the segment to the edge processing unit 31 (step S215).

The edge processing unit 31 generates new MPD and a new segment on the basis of the received MPD to optimally distribute a video stream in accordance with the condition of a client terminal (step S216). The new segment corresponds to the generated MPD or corresponds to the environmental condition of the client. Here, the new segment also includes a segment that is not described in the MPD.

FIG. 9 is a diagram illustrating an example of MPD generated by the edge processing unit 31 in step S216. As illustrated in FIG. 9, the edge processing unit 31 generates new “Representation”, for example, on the basis of large “Representation” having the highest bit rate included in respective “AdaptationSet's”.

Specifically, large “Representation” having the highest bit rate included in “AdaptationSet” of the first FLUS source is “Representation@bandwith=‘mxbr-1(bps)’”. In this case, the edge processing unit 31 generates “Representation@bandwith=‘0.1*mxbr-1(bps)’” on the basis of “Representation@bandwith=‘mxbr-1(bps)’”. In other words, the edge processing unit 31 generates “Representation” having a decreased bit rate on the basis of large “Representation” having the highest bit rate included in “AdaptationSet”.

Large “Representation” having the highest bit rate included in “AdaptationSet” of the second FLUS source is “Representation@bandwith=‘mxbr-3(bps)’”. In this case, the edge processing unit 31 generates “Representation@bandwith=‘0.1*mxbr-3(bps)’” on the basis of “Representation@bandwith=‘mxbr-3(bps)’”. In addition, the edge processing unit 31 generates “Representation@bandwith=‘0.01*mxbr-3(bps)’” on the basis of “Representation@bandwith=‘mxbr-3(bps)’”. The edge processing unit 31 may generate a plurality of “Representation's” each having a decreased bit rate on the basis of large “Representation” having the highest bit rate included in “AdaptationSet”.

In a case where there has already been a segment having a decreased bit rate as indicated in “AdaptationSet” in the MPD corresponding to the third FLUS source, the edge processing unit 31 does not have to generates “Representation” having a decreased bit rate.

The edge processing unit 31 may determine a request from the user terminal 40 or a bit rate value to be generated, for example, in accordance with a request from the user terminal 40. Alternatively, the edge processing unit 31 may determine a bit rate value in accordance with the congestion condition of the network between the edge processing unit 31 and the user terminal 40.

Next, the user terminal 40 requests MPD from the edge processing unit 31 (step S217 and step S218).

Upon receiving the request, the edge processing unit 31 then transmits MPD to the user terminal 40 (step S219 and step S220). This allows the user terminal 40 to select an appropriate segment corresponding to the performance of the user terminal 40 and a desired bit rate on the basis of the MPD received from the edge processing unit 31 and request the selected segment from the edge processing unit 31. In addition, in a case where the user terminal 40 requests MPD from the edge processing unit 31, the user terminal 40 may transmit information such as the performance and positional information of the user terminal to the edge processing unit 31 in advance along with the request of MPD. In addition, the edge processing unit 31 may generate a new optimum segment for the user terminal 40 that is not described in the generated MPD on the basis of the received information regarding the user terminal 40 and transmit the new optimum segment to the user terminal 40.

Next, the user terminal 40 requests a segment corresponding to the desired bit rate from the edge processing unit 31 (step S221 and step S222).

Upon receiving the request, the edge processing unit 31 then transmits the segment to the user terminal 40 (step S223 and step S224). This allows the user terminal 40 to view and listen to a video stream.

Next, the production unit 24 outputs the permitted maximum bit rate value to the source unit 11 (step S225 and step S226). The permitted maximum bit rate value is a value different from that of step S207. This changes the bit rate value of each of the FLUS sources.

Step S227 to step S242 are similar to step S209 to step S224 and description is thus omitted.

It is to be noted that it is described in FIG. 6 that each time section has the same maximum bit rate value permitted to a FLUS source, but the respective time sections may have different maximum bit rate values.

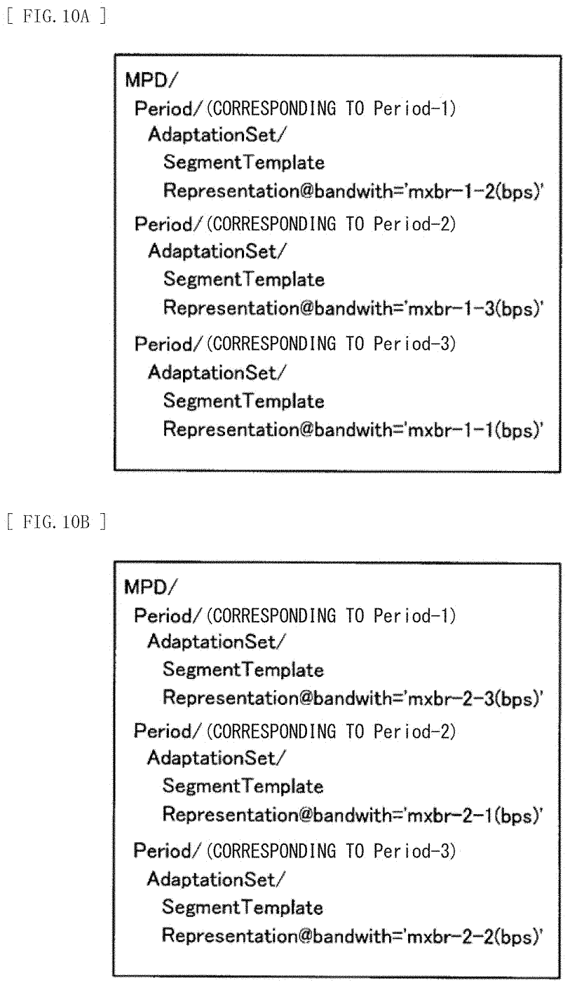

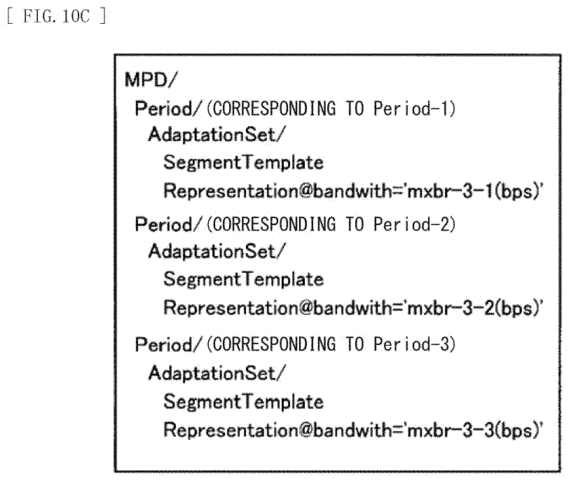

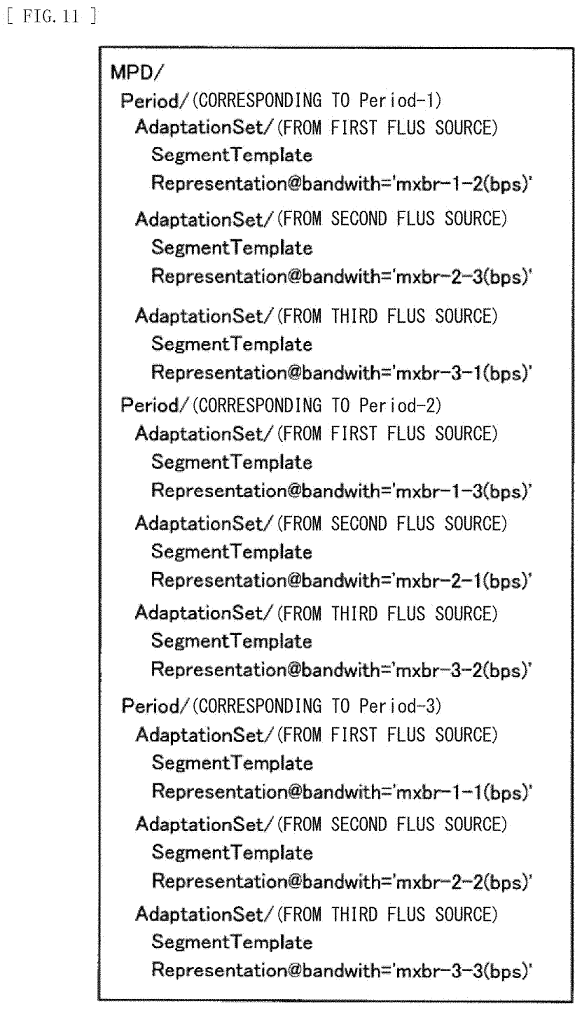

Each of FIGS. 10A, 10B, and 10C is a diagram illustrating an example of MPD generated by the production unit 24 in a case where the respective time sections have different maximum bit rate values permitted. Here, a case is described in which three FLUS sources are instructed to have different bit rate values at three time intervals.

FIG. 10A illustrates MPD of video streams transferred from the first FLUS source. As illustrated in FIG. 10A, the maximum bit rate values set in “Period-1”, “Period-2”, and “Period-3” as time sections are described in the MPD. The maximum bit rate value set in “Period-1” is “Representation@bandwith=‘mxbr-1-2(bps)’”. Here the first number means that the FLUS source is the first FLUS source and the second number is a bit rate value that is set. The maximum bit rate value set in “Period-2” is “Representation@bandwith=‘mxbr-1-3(bps)’”. The maximum bit rate value set in “Period-3” is “Representation@bandwith=‘mxbr-1-1(bps)’”. In other words, the first FLUS has the largest bit rate value in the section of “Period-2” and the smallest bit rate value in the section of “Period-3”.

FIG. 10B illustrates MPD of video streams transferred from the second FLUS source. The maximum bit rate value set in “Period-1” is “Representation@bandwith=‘mxbr-2-3(bps)’”. The maximum bit rate value set in “Period-2” is “Representation@bandwith=‘mxbr-2-1(bps)’”. The maximum bit rate value set in “Period-3” is “Representation@bandwith=‘mxbr-2-2(bps)’”. In other words, the second FLUS has the largest bit rate value in the section of “Period-1” and the smallest bit rate value in the section of “Period-2”.

FIG. 10C illustrates MPD of video streams transferred from the third FLUS source. The maximum bit rate value set in “Period-1” is “Representation@bandwith=‘mxbr-3-1(bps)’”. The maximum bit rate value set in “Period-2” is “Representation@bandwith=‘mxbr-3-2(bps)’”. The maximum bit rate value set in “Period-3” is “Representation@bandwith=‘mxbr-3-3(bps)’”. In other words, the third FLUS has the largest bit rate value in the section of “Period-3” and the smallest bit rate value in the section of “Period-1”.

FIG. 11 is a diagram illustrating an example of MPD generated by the route processing unit 22 in step S212 in a case where the production unit 24 generates the MPD illustrated in each of FIGS. 10A to 10C. As illustrated in FIG. 11, the route processing unit 22 puts together the three MPDs received from the production unit 24 and generates one MPD.

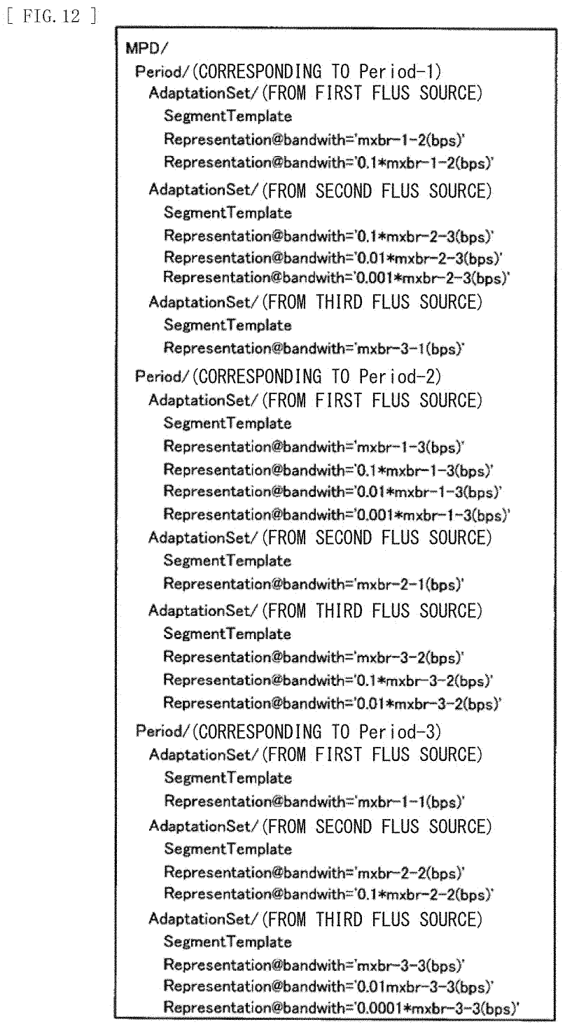

FIG. 12 is a diagram illustrating an example of MPD generated by the edge processing unit 31 in step S216 in a case where the route processing unit 22 generates the MPD illustrated in FIG. 11. As illustrated in FIG. 12, the edge processing unit 31 generates “Representation's” for the respective time sections of each FLUS source. The “Representation's” have different bit rates.

The first FLUS source in “Period-1” is described. In this case, the edge processing unit 31 generates “Representation@bandwith=‘0.1*mxbr-1-2(bps)’” on the basis of “Representation@bandwith=‘mxbr-1-2(bps)’”.

The second FLUS source in “Period-1” is described. In this case, the edge processing unit 31 generates “Representation@bandwith=‘0.1*mxbr-2-3(bps)’” on the basis of “Representation@bandwith=‘mxbr-2-3(bps)’”. In addition, the edge processing unit 31 generates “Representation@bandwith=‘0.01*mxbr-2-3(bps)’” on the basis of “Representation@bandwith=‘mxbr-2-3(bps)’”.

The edge processing unit 31 generates no “Representation” having a decreased bit rate for the third FLUS source in “Period-1”.

The first FLUS source in “Period-2” is described. In this case, the edge processing unit 31 generates “Representation@bandwith=‘0.1*mxbr-1-3(bps)’” on the basis of “Representation@bandwith=‘mxbr-1-3(bps)’”. In addition, the edge processing unit 31 generates “Representation@bandwith=‘0.01*mxbr-1-3(bps)’” on the basis of “Representation@bandwith=‘mxbr-1-3(bps)’”. Further, the edge processing unit 31 generates “Representation@bandwith=0.001*mxbr-1-3(bps)” on the basis of “Representation@bandwith=‘mxbr-1-3(bps)’”.

The edge processing unit 31 generates no “Representation” having a decreased bit rate for the second FLUS source in “Period-2”.

The third FLUS source in “Period-2” is described. In this case, the edge processing unit 31 generates “Representation@bandwith=‘0.1*mxbr-3-2(bps)’” on the basis of “Representation@bandwith=‘mxbr-3-2(bps)’”. In addition, the edge processing unit 31 generates “Representation@bandwith=‘0.01*mxbr-3-2(bps)’” on the basis of “Representation@bandwith=‘mxbr-3-2(bps)’”.

The edge processing unit 31 generates no “Representation” having a decreased bit rate for the first FLUS source in “Period-3”.

The second FLUS source in “Period-3” is described. In this case, the edge processing unit 31 generates “Representation@bandwith=‘0.01*mxbr-2-2(bps)’” on the basis of “Representation@bandwith=‘mxbr-2-2(bps)’”.

The third FLUS source in “Period-3” is described. In this case, the edge processing unit 31 generates “Representation@bandwith=‘0.01*mxbr-3-3(bps)’” on the basis of “Representation@bandwith=‘mxbr-3-3(bps)’”. In addition, the edge processing unit 31 generates “Representation@bandwith=‘0.0001*mxbr-3-2(bps)’” on the basis of “Representation@bandwith=‘mxbr-3-3(bps)’”.

In this way, the edge processing unit 31 may generate “Representation's” that are different in number between the respective FLUS sources and between the respective time intervals. In addition, it may be different between the respective FLUS sources and between the respective time intervals how much the bit rates of “Representation's” to be generated are decreased.

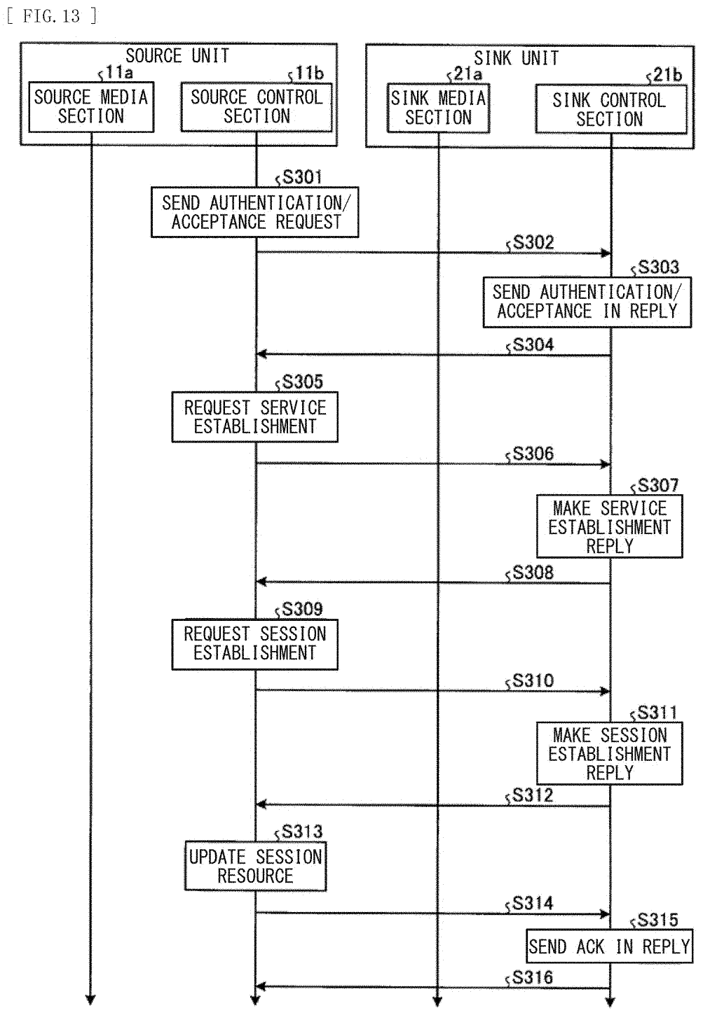

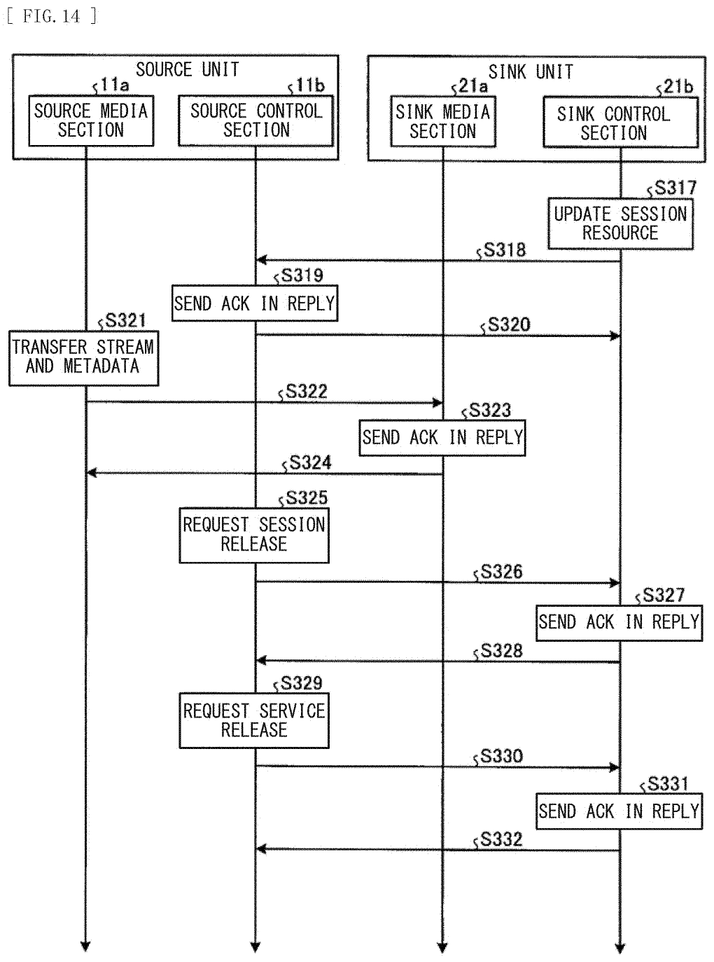

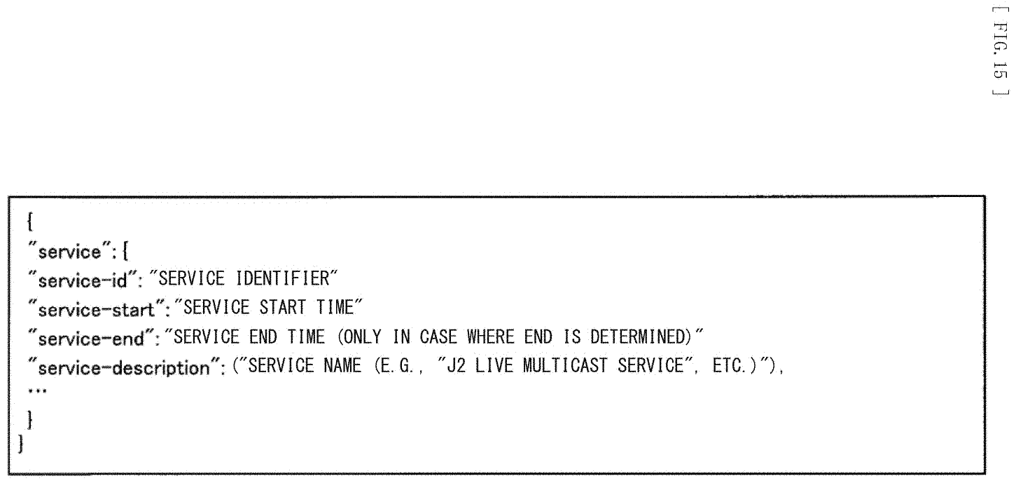

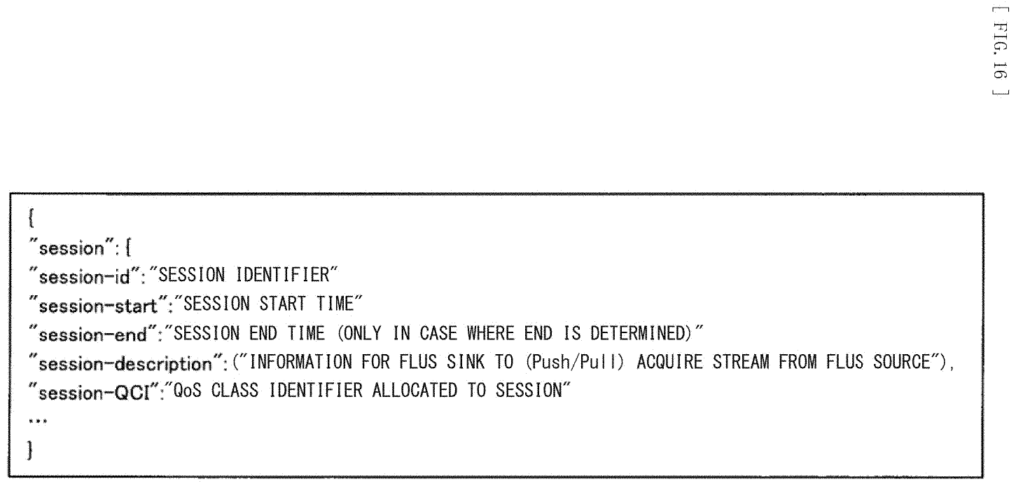

Next, with reference to FIGS. 13 and 14, a method of establishing a FLUS session between the source unit 11 and the sink unit 21 is described. Each of FIGS. 13 and 14 is a sequence diagram illustrating a processing flow between the source unit 11 and the sink unit 21.

As illustrated in FIG. 13, the source unit 11 includes a source media section 11a and a source control section 11b. The sink unit 21 includes a sink media section 21a and a sink control section 21b. The source media section 11a and the sink media section 21a are used to transmit and receive video streams. The source control section 11b and the sink control section 21b are used to establish FLUS sessions.

First, the source control section 11b transmits an authentication/acceptance request to the sink control section 21b (step S301 and step S302). Upon receiving the authentication/acceptance request, the sink control section 21b then outputs an access token to the source control section 11b to reply to the authentication/acceptance request (step S303 and step S304). The processing from step S301 to step S304 is performed one time before a service is established.

Next, the source control section 11b transmits a service establishment request to the sink control section 21b (step S305 and step S306). Specifically, the source control section 11b requests a service to be established by POST of the HTTP methods. Here, the body of the POST communication is named as “ServiceResource”.

FIG. 15 is a diagram illustrating an example of “ServiceResource”. “ServiceResource” includes, for example, “service-id”, “service-start”, “service-end”, and “service-description”.

“service-id” stores a service identifier (e.g., service ID (value)) allocated to each service. “service-start” stores the start time of a service. “service-end” stores the end time of a service. In a case where the end time of a service is not determined, “service-end” stores nothing. “service-description” stores, for example, a service name such as “J2 multicast service”.

Upon receiving a service establishment request, the sink control section 21b then transmits a reply of service establishment to the source control section 11b (step S307 and step S308). Specifically, the sink control section 21b transmits HTTP 201 CREATED to the source control section 11b as an HTTP status code. In a case where the service establishment results in success, a predetermined value is stored in “service-id” of “ServiceResource” generated by the sink control section 21b. The processing from step S305 to step S308 is performed one time when a service is established.

Next, the source control section 11b transmits a session establishment request to the sink control section 21b (step S309 and step S310). Specifically, the source control section 11b requests a session to be established by POST of the HTTP methods. Here, the body of the POST communication is named as “SessionResource”.

FIG. 16 is a diagram illustrating an example of “SessionResource”. “SessionResource” includes, for example, “session-id”, “session-start”, “session-end”, “session-description”, and “session-QCI”.

“session-id” stores a service identifier (e.g., session ID (value)) allocated to each session. “session-start” stores the start time of a session. “session-end” stores the end time of a session. In a case where the end time of a service is not determined, “session-end” stores nothing. “session-description” stores information for a sink unit 12 to perform Push or Pull acquisition of a video stream from the source unit 11. “session-QCI (QoS Class Identifier)” stores a class identifier allocated to a session.

Specifically, in a case of Pull acquisition, “session-description” stores the URL of the MPD of the corresponding video stream or the MPD itself. In a case where a session is described by DASH-MPD, a video stream is transferred by HTTP(S)/TCP/IP or HTTP2/QUIC/IP.

In addition, in a case of Push acquisition, “session-description” stores the URL of the SDP (Session Description Protocol) of the corresponding video stream. In a case where a session is described by SDP, a video stream is transferred by ROUTE (FLUTE)/UDP/IP, RTP/UDP/IP, or the like.

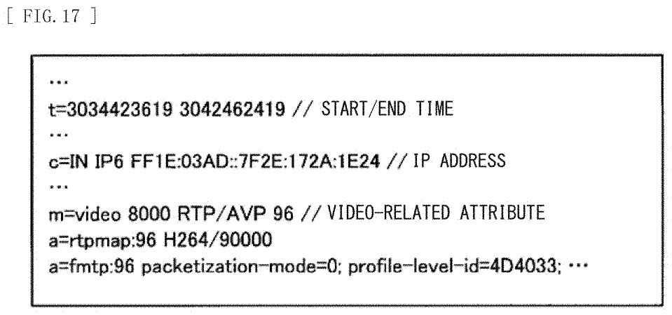

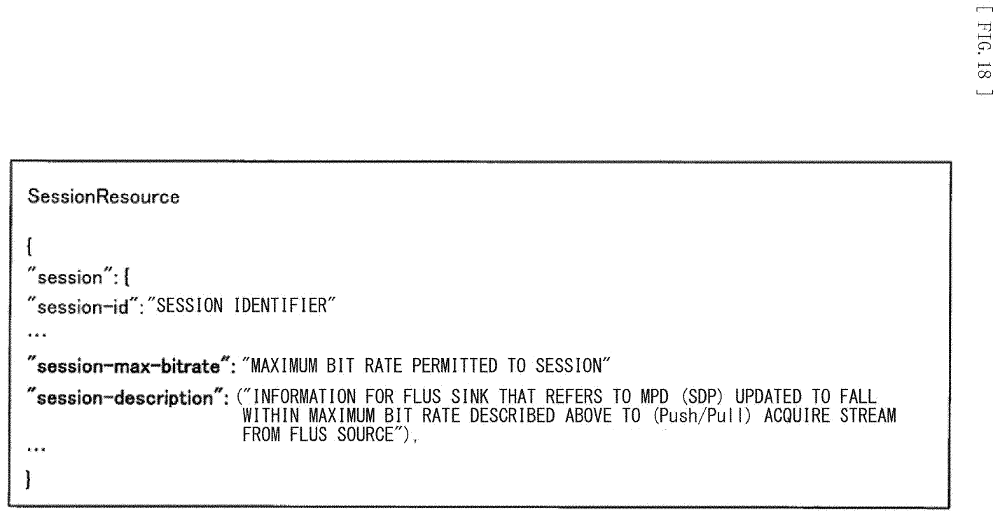

FIG. 17 is a diagram illustrating an example of SDP. As illustrated in FIG. 17, the start time and the end time of a video stream, an IP address, a video-related attribute, and the like are described.

Upon receiving a session establishment request, the sink control section 21b then transmits a reply of session establishment to the source control section 11b (step S311 and step S312). Specifically, the sink control section 21b transmits HTTP 201 CREATED to the source control section 11b as an HTTP status code. In a case where the service establishment results in success, a predetermined value is stored in “session-id” of “SessionResource” generated by the sink control section 21b. The processing from step S309 to step S312 is performed one time when a session is established.

To change an attribute of a session in the source unit 11 (or the sink unit 21), “SessionResource” is updated on the source unit 11 (or the sink unit 21) side and the sink unit 21 (or the source unit 11) side is notified thereof (step S313 and step S314). Specifically, the source control section 11b (or the sink control section 21b) notifies the sink unit 21 (or the source unit 11) of updated “SessionResource” by PUT of the HTTP methods.

FIG. 18 is a diagram illustrating an example of “SessionResource” in which the maximum bit rate and updated “session-description” are stored in “SessionResource” on the sink unit 21 side. “session-max-bitrate” is the maximum bit rate permitted to a session. Here, “session-max-bitrate” means FLUS-MaxBitrate described above. Updated “session-description” stores information for the FLUS sink that refers to MPD (SDP) updated to fall within the maximum bit rate to perform Push or Pull acquisition of a video stream from the FLUS source. It is to be noted that, as a message between FLUSes, a maximum bit rate is introduced as “session-max-bitrate”, but this is an example. This does not limit the present disclosure. The present disclosure may extend, for example, MPD itself to issue a notification of a maximum bit rate value.

Upon receiving updated “SessionResource”, the sink control section 21b then sends ACK (Acknowledge) to the source control section 11b in reply (step S315 and step S316). The ACK (Acknowledge) is an affirmative reply indicating that data is received. Specifically, in a case where a session results in success, the sink control section 21b transmits HTTP 200 OK to the source control section 11b as an HTTP status code. In this case, the URL of updated “SessionResource” is described in the HTTP Location header.

Next, with reference to FIG. 14, the processing subsequent to FIG. 13 is described.

Step S317 and step S318 are different from step S313 and step S314 only in that the processing is executed by the sink control section 21b. Specific description is thus omitted. Here, the sink control section 21b notifies the source control section of the maximum bit rate value as illustrated in FIG. 18.

Step S319 and step S320 are different from step S315 and step S316 only in that the processing is executed by the source control section 11b. Specific description is thus omitted.

Next, the source media section 11a distributes a video stream and a metadata file to the sink media section 21a (step S321 and step S322). This allows the sink unit 21 side to distribute video data to a user. Upon receiving the video stream and the metadata file, the sink media section 21a then sends ACK to the source media section 11a in reply (step S323 and step S324). The ACK is an affirmative reply indicating that data is received.

Next, the source control section 11b notifies the sink control section 21b of a session release request (step S325 and step S326). Specifically, the source control section 11b notifies the sink control section 21b of the URL of corresponding “SessionResource” by DELETE of the HTTP methods.

Upon receiving the session release request, the sink control section 21b then sends ACK to the source control section 11b in reply (step S327 and step S328). The ACK is an affirmative reply indicating that data is received. Specifically, the sink control section 21b transmits HTTP 200 OK to the source control section 11b as an HTTP status code. In this case, the URL of released “SessionResource” is described in the HTTP Location header.

Next, the source control section 11b notifies the sink control section 21b of a service release request (step S329 and step S330). Specifically, the source control section 11b notifies the sink control section 21b of the URL of corresponding “ServiceResource” by DELETE of the HTTP methods.

Upon receiving the service release request, the sink control section 21b then sends ACK to the source control section 11b in reply (step S331 and step S332). The ACK is an affirmative reply indicating that data is received. Specifically, the sink control section 21b transmits HTTP 2000K to the source control section 11b as an HTTP status code. The URL of released “ServiceResource” is described in the HTTP Location header. The established session then ends.

As described above, the present embodiment makes it possible to optionally control the bit rate values of video streams uplinked from imaging devices coming from different vendors and having a plurality of grades. This makes it possible to efficiently select and provide a video stream in which the intention of a producer is reflected and a viewer and listener seems to be interested. In other words, the present embodiment makes it possible to preferentially allocate sufficient bands to a source in which a user seems to be interested even in a case where there is a constraint on the total bandwidth of live uplink streams from a plurality of imaging devices. Here, the “total bandwidth of the live uplink streams” means total bandwidth necessary (reserved) to uplink video streams that have to be distributed in real time. cl 2. Second Embodiment

Next, a second embodiment of the present disclosure is described.

In the first embodiment, in a case where there are especially sufficient redundant uplink bands, the use of the redundant bands makes it possible to uplink a video stream of a high image quality version in parallel with a live up stream. It is therefore announced in the second embodiment that it is going to be possible to view and listen to the video stream as a high image quality version a little time after an edge of the video stream. This allows a user to view and listened to video of a high image quality version by waiting for the announced time after video is temporarily reproduced or making a pause in video and then reproducing the video.

The first embodiment takes into consideration a constraint that a total band has to fall within given bandwidth, for example, because of a cost constraint or the like. The total band is obtained by adding up all session groups of capture streams from a plurality of imaging devices. The capture streams are subjected to live simultaneous recording.

Here, a case is considered in which there is further a redundant band for connection to each of camera sources in addition to a band allocated to a session for transferring a live recording capture stream from each of the imaging devices. In this case, a band may be possibly secured by decreasing the grade (cost) of the QoS within the range of the redundant band as compared with the session for live simultaneous recording. High image quality versions of live capture streams transferred in the sessions for live simultaneous recording may be possibly transferred simultaneously little by little.

Such session management, however, has a problem that it is not possible to announce, for example, by using MPD that a high image quality version may be possibly delivered with delay in the future. The MPD is control metadata of DASH streaming. This is because an update mechanism of MPD especially in live distribution does not have information about past Period in general.

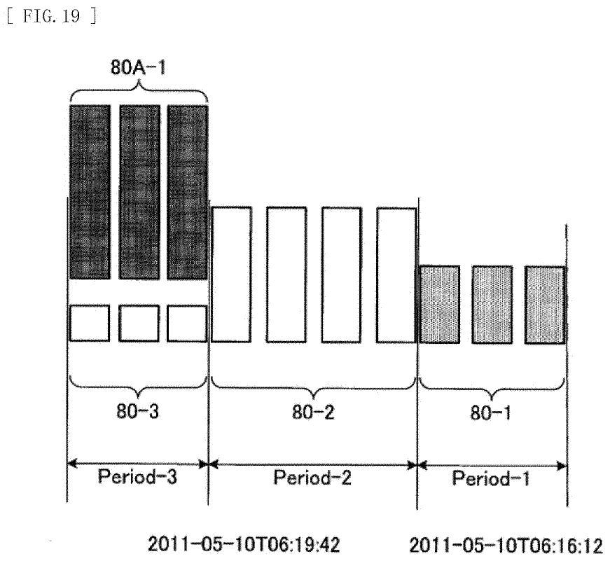

FIG. 19 is a diagram for describing a video stream that is uplinked in each of Period's. FIG. 19 illustrates that a video stream 80-1 is uplinked in Period-1. Here, it is assumed that the start time of Period-1 is six sixteen and twelve seconds on May 10, 2011. It is meant that a video stream 80-2 is uplinked in Period-2. It is meant that a video stream 80-3 is uplinked in Period-3. In addition, it is meant that a video stream 80A-1 is uplinked in Period-3. The video stream 80A-1 is a high image quality version of the video stream in Period-1. Here, it is assumed that the start time of Period-3 is six nineteen and forty-two seconds on May 10, 2011.

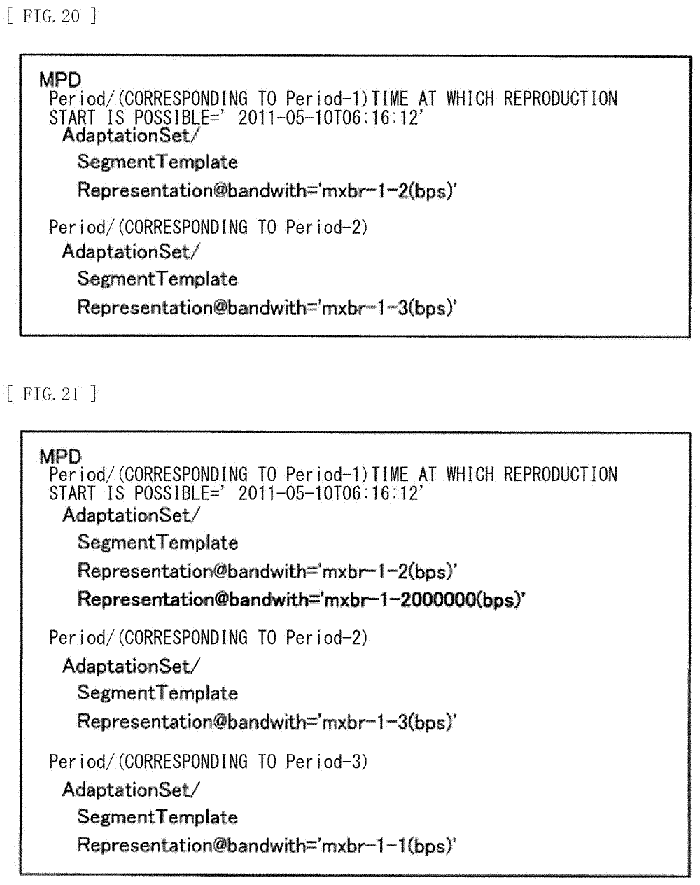

For example, in FIG. 19, MPD generally has only information about the video stream reproduced in Period-1 and information about the video stream to be reproduced in Period-2 at the start time point of Period-2. FIG. 20 is a diagram illustrating an example of MPD acquirable at the start time point of Period-2. As illustrated in FIG. 20, “Representation” of “AdaptationSet” of Period-1 describes “@bandwith=‘mxbr-1-2(bps)’”. In other words, it is not possible to acquire, at the start time point of Period-2, information indicating that there is a high image quality version of the video stream 80-1.

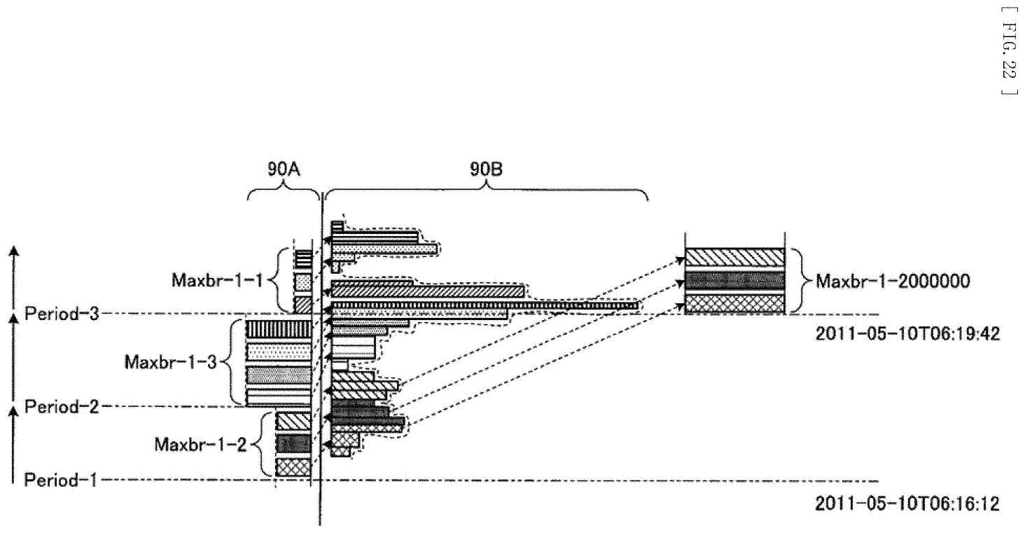

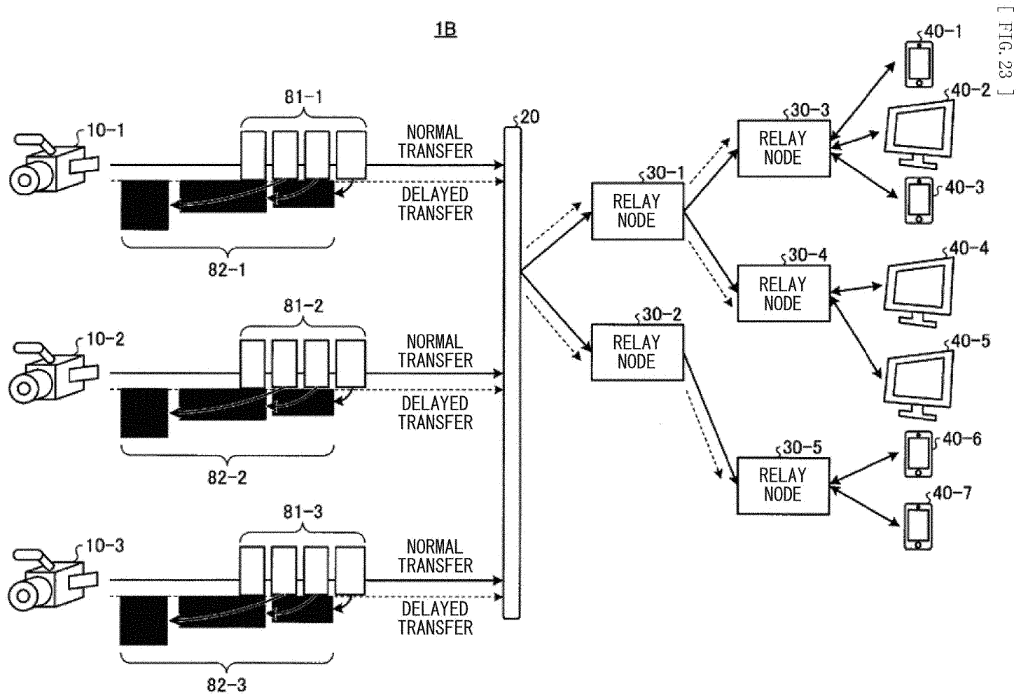

Here, the conventional update mechanism of MPD describes as illustrated in FIG. 21 to express the availability of a high image quality version of the video stream in Period-1. FIG. 21 illustrates MPD acquirable at the start time point of Period-3. As illustrated in FIG. 21, “Representation” of “AdaptationSet” of Period-1 includes “@bandwith=‘mxbr-1-2000000(bps)’”. In other words, it is clear at the start time point of Period-3 that high image quality versions of the video streams in the past Period's are available. There is a problem that a user is unable to view and listen to the video stream in Period-1 as a high image quality version from the start by making a temporary pause in the reproduced video stream before starting the video stream.

FIG. 22 is a schematic diagram illustrating video streams are transferred in different sessions in the same service. The different sessions are established by using redundant bands. In FIG. 22, a session 90A means a high-cost session having high QoS guarantee. A session 90B is a low-cost session that only allows for low QoS guarantee. In other words, the service illustrated in FIG. 22 includes a session having high QoS guarantee and a session having low QoS guarantee. In such a case, a high image quality version of the video stream in Period-1 is prepared to allow for reproduction at the start time point of Period-3 having a redundant band.

FIG. 23 is a schematic diagram illustrating a configuration of a distribution system 1B according to the second embodiment. FIG. 23 includes the three imaging devices of the imaging devices 10-1 to 10-3, but this is an example. This does not limit the present disclosure.

The imaging device 10-1 distributes, for example, a video stream 81-1 to the distribution device 20. The imaging device 10-1 distributes, for example, a high image quality video stream 82-1 to the distribution device 20 later than the video stream 81-1. The high image quality video stream 82-1 is a high image quality version of the video stream 81-1.

The imaging device 10-2 distributes, for example, a video stream 81-2 to the distribution device 20. The imaging device 10-1 distributes, for example, a high image quality video stream 82-2 to the distribution device 20 later than the video stream 81-2. The high image quality video stream 82-2 is a high image quality version of the video stream 81-2.

The imaging device 10-3 distributes, for example, a video stream 81-3 to the distribution device 20. The imaging device 10-3 distributes, for example, a high image quality video stream 82-3 to the distribution device 20 later than the video stream 81-3. The high image quality video stream 82-3 is a high image quality version of the video stream 81-3.

The distribution device 20 performs predetermined processing on the video streams 81-1 to 81-3 and distributes the video streams 81-1 to 81-3 to the relay nodes 30-1 and 30-2. The distribution device 20 performs predetermined processing on the high image quality video streams 82-1 to 82-3 and distributes the high image quality video streams 82-1 to 82-3 to the relay nodes 30-1 and 30-2 later than the distribution of the video streams 81-1 to 81-3. Here, the distribution of the video streams 81-1 to 81-3 is sometimes referred to as normal distribution and the distribution of the high image quality video streams 82-1 to 82-3 is sometimes referred to as delayed distribution. FIG. 23 illustrates normal distribution by a solid-line arrow and illustrates delayed distribution by a dashed-line arrow.

The distribution system 1B newly introduces an element “DelayedUpgrade” to MPD to suggest that it is possible to view and listen to video of a high image quality version after some time passes. This makes it possible to notify a user that the user may be possibly able to view and listen to a high image quality version of a video stream of a parent element designated by “DelayedUpgrade” if the user waits until designated hint time.

The following describes a case in which the FLUS sink of the imaging device 10-1 generates MPD. The processing of the imaging devices 10-2 and 10-3 is similar to the processing of the imaging device 10-1 and description is thus omitted.

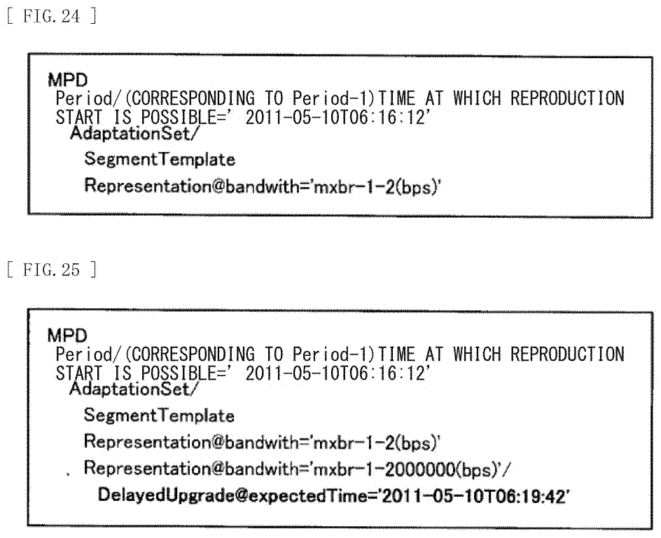

The FLUS sink generates MPD. The FLUS sink defines the maximum bit rate value permitted to the FLUS source as FLUS-MaxBitrate (Service.Session[1.1].session-max-bitrate=mxbr-1-2(bps)) and notifies the FLUS source thereof. Here, the FLUS sink and the FLUS source are the source unit 11-1 and the sink unit 21 illustrated in FIG. 3, respectively. Here, “Service.Session[1.1]” means the first session of the first FLUS source. FIG. 24 is a diagram illustrating an example of MPD of which the FLUS sink notifies the FLUS source. As illustrated in FIG. 24, the MPD indicates that the start time of a video stream is six sixteen and twelve seconds on May 10, 2011. “AdaptationSet” includes “Representation@bandwith=‘mxbr-1-2(bps)’”. This session is a proxy live stream session. It is assumed that this session is designated as a session (Service.Session[1.1].session-QCI=high class) in a high-cost class.

Next, the FLUS source adds DelayedUpgrade to the MPD and defines it as (Service.Session[1.1].session-description=updated MPD). The FLUS source notifies the FLUS sink thereof. FIG. 25 is a diagram illustrating an example of MPD of which the FLUS source notifies the FLUS sink. As illustrated in FIG. 25, the FLUS source adds “Representation” of a high image quality version of first “Representation@bandwith=‘mxbr-1-2(bps)’”. Specifically, the FLUS source adds “Representation@bandwith=‘mxbr-1-2000000(bps)’” as second “Representation”. The FLUS source then adds DelayedUpgrade as an attribute of second “Representation”. Specifically, the FLUS source adds “DelayedUpgrade@expectedTime‘2011-05-10T06:19:42’”. Here, “expectedTime” means time at which a user may be possibly able to view and listen to a video stream of a high image quality version. In other words, “DelayedUpgrade@expectedTime‘2011-05-10T06:19:42’” means that a user may be possibly able to view and listen to a video stream of a high image quality version if waiting until six nineteen and forty-two seconds on May 10, 2011. More specifically, “DelayedUpgrade@expectedTime‘2011-05-10T06:19:42’” indicates a hint that a video stream of a high image quality version of the first segment of corresponding “AdaptationSet” is highly likely to be available if a user waits for a predetermined time. In this case, a video stream of a high image quality version of the first segment of corresponding “AdaptationSet” may be available during the stream session (e.g., some minutes later) in some cases while a video stream of a high image quality version of the first segment of corresponding “AdaptationSet” may be set after the stream session ends (e.g., some tens of minutes later) in other cases.

Next, the FLUS sink adds (Service.Session[1.2]) to the service as a new session and notifies the FLUS source thereof. This session is a delayed stream session (FLUS-Maxbitrate is not designated). In addition, it is assumed that this session is designated as a session (Service.Session[1.2].session-QCI=low class) in a low-cost class. Here, for the delayed stream session, “session-description” is designated (shared) as the above (Service.session[1.1]). In other words, “Service.Session[1.2].session-description=the above-described updated MPD” is assumed.

The FLUS sink executes a session in a high-QoS class with the FLUS source on the basis of the generated MPD. This causes the FLUS sink to acquire a proxy live stream (first Representation) at the time of each segment designated by “SegmentTemplate”. Along with this, the FLUS sink executes a low-QoS-class session with the FLUS source. This causes the FLUS sink to acquire a delayed stream (second Representation). It is not, however, possible to acquire the delayed stream in real time. This causes the FLUS sink to acquire the delayed stream by “SegmentURL” generated from “SegmentTemplate”. It is, however, assumed that the FLUS sink recognizes the acquisition time as unstable and repeats polling as appropriate.

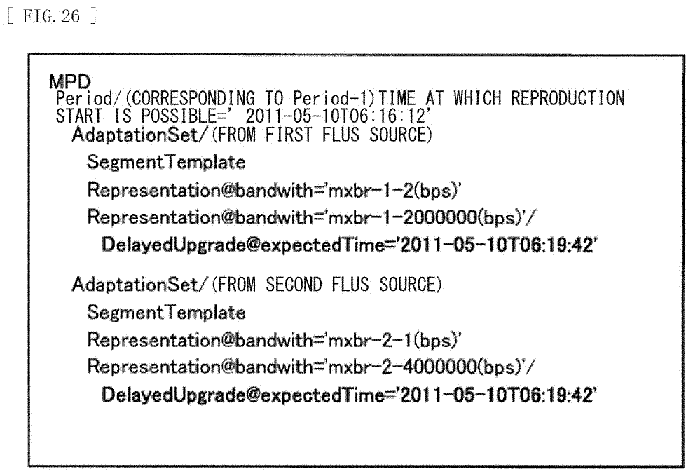

The FLUS sink outputs the generated MPD and segment to the route processing unit 22 (see FIG. 3) via the production unit 24. The route processing unit 22 receives the MPD illustrated in FIG. 25 from a FLUS source implemented in each of imaging devices. The route processing unit 22 then generates MPD as illustrated in FIG. 26.

FIG. 26 is a diagram illustrating an example of MPD generated by the route processing unit 22. The MPD illustrated in FIG. 26 includes “AdaptationSet's” of each of two FLUS sources.

“AdaptationSet” of the first FLUS source includes two “Representation's”. The first is “Representation@bandwith=‘mxbr-1-2(bps)’” and the second is “Representation@bandwith=‘mxbr-1-200000 (bps)’”. “DelayedUpgrade@expectedTime‘2011-05-10T06:19:42’” is then added to second “Representation”.

“AdaptationSet” of the second FLUS source includes two “Representation's”. The first is “Representation@bandwith=‘mxbr-2-1(bps)’” and the second is “Representation@bandwith=‘mxbr-2-400000(bps)’”. “DelayedUpgrade@expectedTime‘2011-05-10T06:19:42’” is then added to second “Representation”.

The route processing unit 22 transfers the MPD illustrated in FIG. 26 and the segment from each of FLUS sources to the edge transfer unit 32 along a multicast tree (see FIGS. 1 and 3). The edge transfer unit 32 outputs the received MPD and segment to the edge processing unit 31.

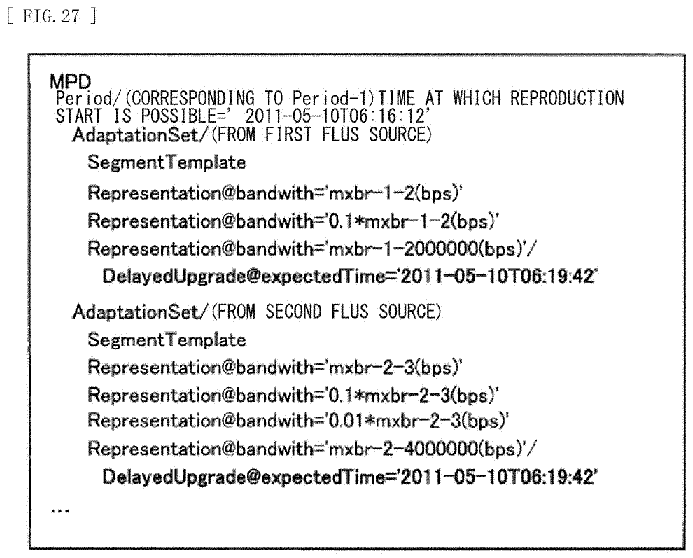

The edge processing unit 31 generates “Representation” and adds “Representation” to the MPD on the basis of a variety of attributes of a user terminal to which a video stream is outputted, statistic information about requests from a user, and the like. This causes the edge processing unit 31 to generate MPD as illustrated in FIG. 27.

FIG. 27 is a diagram illustrating an example of MPD generated by the edge processing unit 31. As illustrated in FIG. 27, one “Representation” is added to “AdaptationSet” of the first FLUS source. Specifically, “Representation@bandwith=‘0.1*mxbr-1-2(bps)’” is added to “AdaptationSet” of the first FLUS source. Two “Representation's” are added to “AdaptationSet” of the second FLUS source. Specifically, “Representation@bandwith=‘0.1*mxbr-2-3(bps)’” and “Representation@bandwith=‘0.01*mxbr-2-3(bps)’” are added to second “AdaptationSet”.

The edge processing unit 31 generates MPD as illustrated in FIG. 27 and then replies, for example, to an MPD acquisition request from the user terminal 40-1.

The user terminal 40-1 refers to MPD as illustrated in FIG. 27 to detect the presence of “Representation” provided with “DelayedUpgrade”. The user terminal 40-1 then performs an interaction and the like with the user. The user terminal 40-1 waits until the time described in “expectedTime” and then acquires MPD again. The user terminal 40-1 performs time shift reproduction. It is to be noted that the user terminal 40-1 does not have to perform an interaction or the like in a case where it is possible to determine the tendency to view and listen to a high image quality version on the basis of statistic information about past viewing and listening modes of the user.

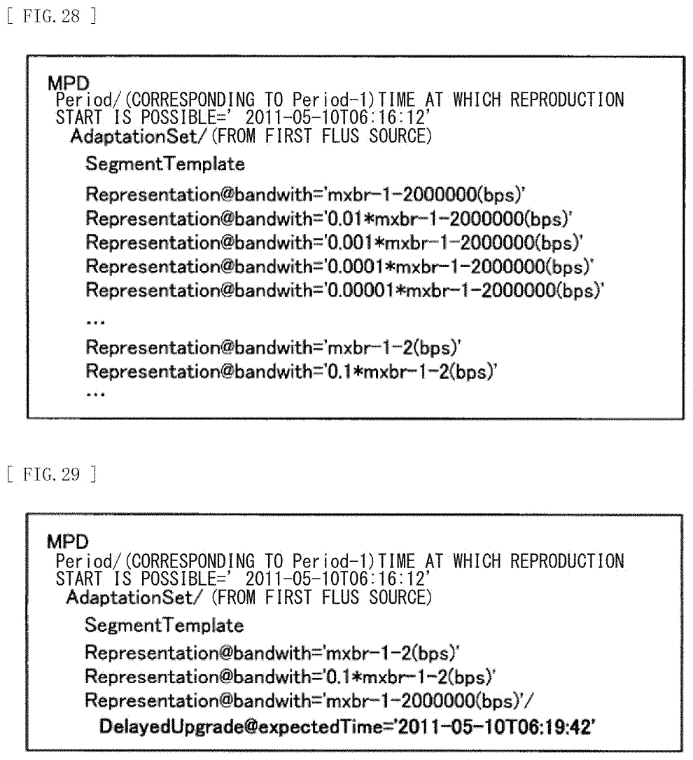

FIG. 28 is a diagram illustrating an example of MPD acquired again. As illustrated in FIG. 28, four “Representation's” are newly generated in first “AdaptationSet”. These four “Representation's” are generated on the basis of “Representation” of a high image quality version. Specifically, “Representation@bandwith=‘0.01*mxbr-1-2000000(bps)’” is generated as the first. “Representation@bandwith=‘0.001*mxbr-1-2000000(bps)’” is generated as the second. “Representation@bandwith=‘0.0001*mxbr-1-2000000(bps)’” is generated as the third. “Representation@bandwith=‘0.00001*mxbr-1-2000000(bps)’” is then generated as the fourth.

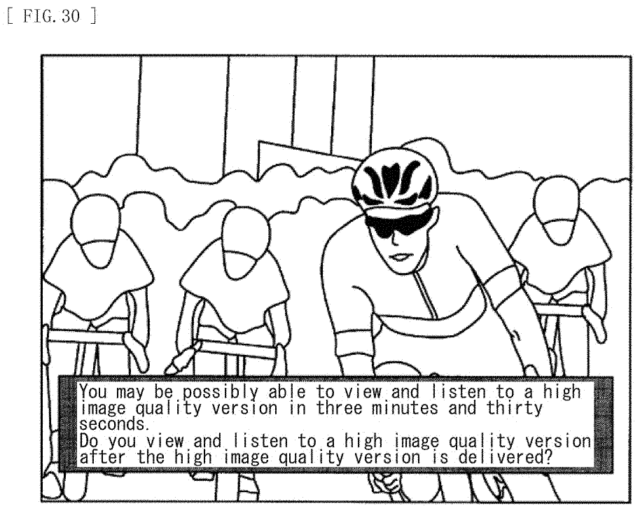

Here, an example of an interaction between the user terminal 40-1 and the user is described. FIG. 29 is a diagram illustrating an example of MPD acquired by the user terminal 40-1. It is assumed that FIG. 29 illustrates MPD acquired from the first FLUS source. As illustrated in FIG. 29, “Representation@bandwith=‘mxbr-1-2000000(bps)’” is provided with “DelayedUpgrade@expectedTime‘2011-05-10T06:19:42’”.

With reference to FIG. 30, an operation of the distribution system 1B according to the second embodiment is described. FIG. 30 illustrates a video stream corresponding to the MPD illustrated in FIG. 29. As illustrated in FIG. 30, in a case where the user terminal 40-1 receives MPD as illustrated in FIG. 29, the user terminal 40-1 causes, for example, a message to be displayed such as “You may be possibly able to view and listen to a high image quality version in three minutes and thirty seconds. Do you view and listen to a high image quality version after the high image quality version is delivered?”. This allows a user who wishes to view and listen to a high image quality version to view and listen to a high image quality version of a video stream by pausing or waiting a little here.

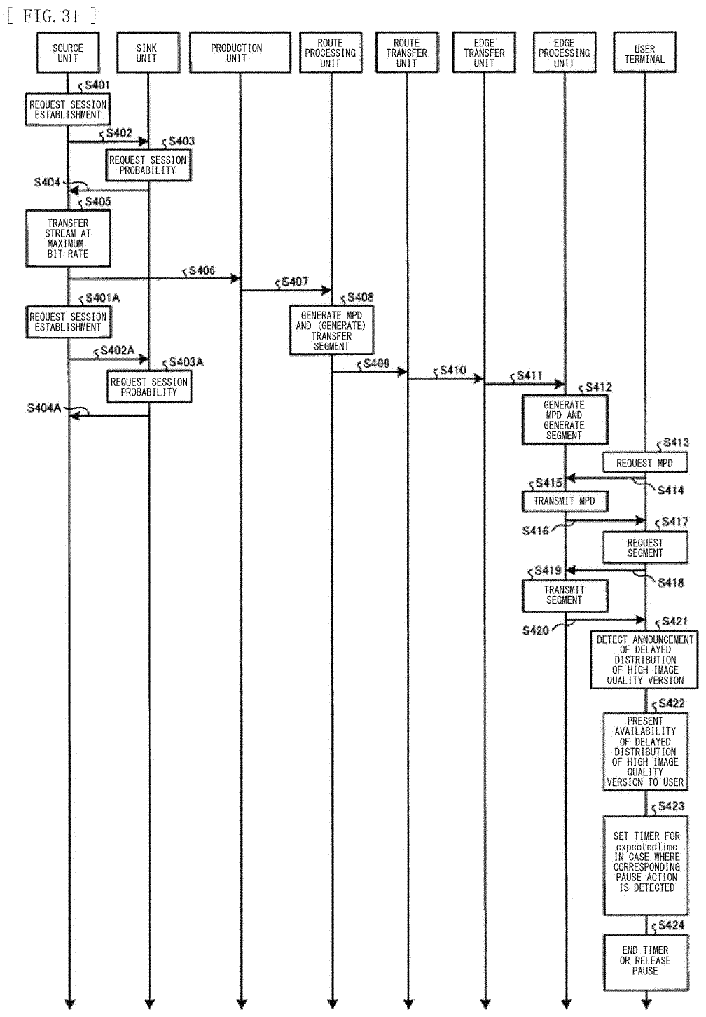

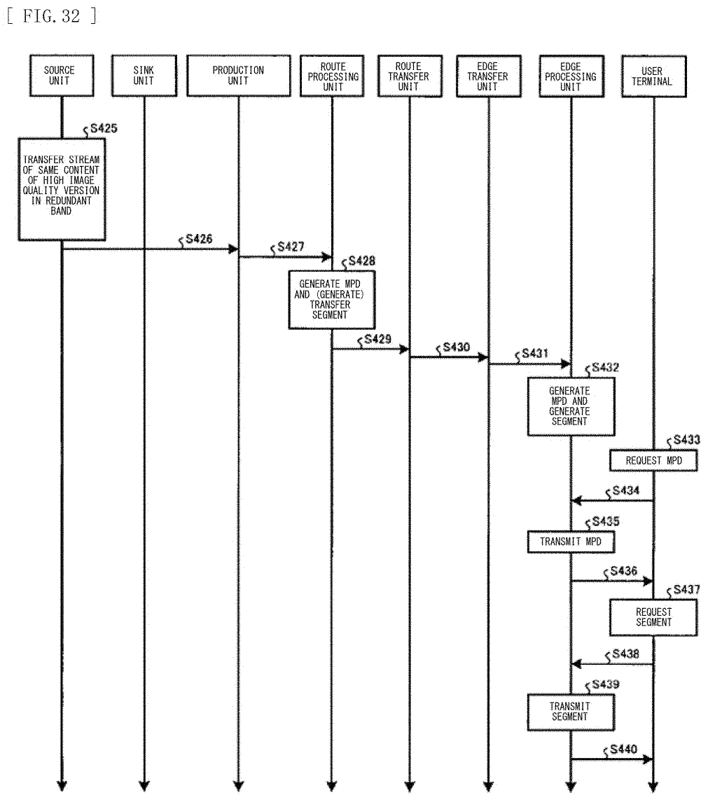

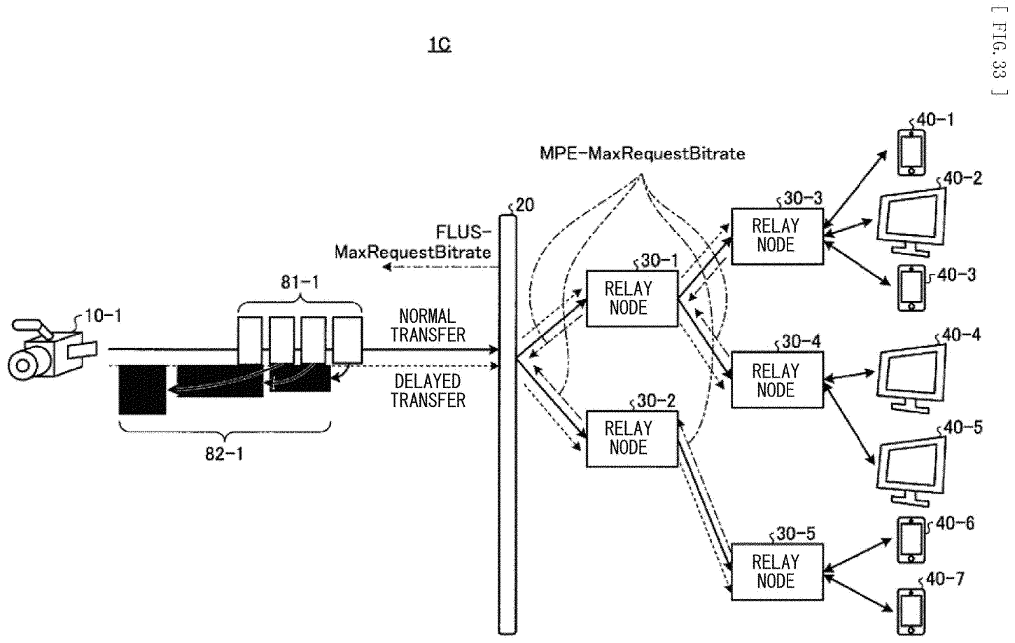

With reference FIGS. 31 and 32, an example of a processing flow of the distribution system 1B according to the second embodiment is described. Each of FIGS. 31 and 32 is a flowchart illustrating an example of a processing flow of the distribution system 1B according to the second embodiment. It is to be noted that description is given in FIGS. 31 and 32 by assuming that a multicast tree is configured in the method illustrated in FIG. 6.

Step S401 to step S404 are the same as step S201 to step S204 illustrated in FIG. 6 and description is thus omitted.

In parallel with step S401 to step S404, another session for transferring a delayed stream having the same content in a redundant band is established in the same service (step S401A to step S404A). It is to be noted that “session-QCI” of the session established here indicates a class having lower priority than that of “session-QCI” of the session established in step S401 to step S404 as described above.

After step S404, the source unit 11 transmits a video stream to the production unit 24 at the maximum bit rate value about which the source unit 11 has been instructed (step S405 and step S406).

The production unit 24 outputs a video stream to the route processing unit 22 (step S407).

Step S408 to step S412 are the same as step S212 to step S216 illustrated in FIG. 6 except that MPD generated and distributed includes “DelayedUpgrade”. Description is thus omitted.

After step S412, the user terminal 40 requests MPD from the edge processing unit 31 (step S413 and step S414). Upon receiving the request of MPD, the edge processing unit 31 transmits MPD to the user terminal 40 (step S415 and step S416).

Next, the user terminal 40 requests a desired segment on the basis of the MPD received from the edge processing unit 31 (step S417 and step S418). Upon receiving the request of a segment, the edge processing unit 31 transmits the segment corresponding to the request (step S419 and step S420).

The user terminal 40 detects an announcement of the delayed distribution of a high image quality version on the basis of “DelayedUpgrade” included in the received MPD (step S421). The user terminal 40 then presents the availability of the delayed distribution of a high image quality version to the user (step S422). In a case where a corresponding pause action of the user is detected, the user terminal 40 sets a timer for the time indicated in “expectedTime” (step S423). The user terminal then detects the end of the timer and detects the release of the pause (step S424). This allows the user to view and listen to a video stream of a high image quality version.

With reference to FIG. 32, the processing subsequent to FIG. 31 is described.

The source unit 11 performs stream transfer in a redundant band on a high image quality version of the stream that is the same as the stream distributed in step S405 (step S425 and step S426).

Step S427 to step S431 are the same as step S407 to step 411 and description is thus omitted.

After step S431, the edge processing unit 31 generates MPD and a segment of the video stream of a high image quality version (step S432). Here, as illustrated in FIG. 28, “Representation's” of a plurality of versions based on “Representation” of a high image quality version are generated. In a case where a user acquires such MPD immediately before “expectedTime”, a desired video stream may be selected from “Representation's” of a plurality of versions that are newly generated.

Step S433 to step S440 are the same as step S413 to step S420 and description is thus omitted. The above-described processing allows a user below to view and listen to high image quality versions of a variety of video streams later than the live distribution.

As described above, while a user is viewing and listening to live streaming, it is possible in the second embodiment to notify the user that a video stream of a high image quality version is going to be distributed with delay. This allows the user to view and listen to a video stream of a high image quality version later by stopping a video stream that the user is currently viewing and listening to in a case where the user wishes to view and listen to the video stream of a high image quality version.

### 3. Third Embodiment

Next, a third embodiment of the present disclosure is described.

In the second embodiment, an uplink streaming band usually has a value that is set regardless of the situation of a request from a user. Even in a case where the band for transferring a video stream therefore has a redundant region and each of users desires a video stream of a higher image quality version than usual, there is a possibility that the redundant band is not sufficiently used. In contrast, in the third embodiment, a value is set in which the maximum bit rate value requested by a monitored user is reflected. Accordingly, in a case where a session for transferring a stream from each of sources has a redundant band, it is possible to effectively use that.

Although specifically described below, in the third embodiment, MPE-MaXRequestBitrate is introduced as an MPE message for a notification consecutively indicating the maximum bit rate value requested by a user. This causes the edge transfer unit 32 to notify the route transfer unit 23 of the maximum bit rate value requested by a user group.

In addition, in the third embodiment, FLUS-MaxRequestBitrate is introduced as a FLUS message. This causes the FLUS sink to notify the individual imaging devices of the maximum request bit rate value (FLUS-MaxRequestBitrate) of a user group. All of the imaging devices that receive FLUS-MaxRequestbitrate perform proxy live uplink at the value described in MaxRequestBitrate. Along with this, a high image quality version (encode version or baseband version) is uplinked in a redundant band. It is to be noted that MaxRequestbitrate is introduced in the third embodiment as a method of acquiring the maximum value of desired bit rate values from a user, but this is an example. This does not limit the present disclosure. The present disclosure may extend, for example, MPD to achieve a similar function.

Here, a different is described between FLUS-MaxRequestbitrate and FLUS-Maxbitrate described in the first embodiment. FLUS-Maxbitrate is given as an instruction from the sink side. The source side controls live uplink streaming within the maximum band indicated by FLUS-Maxbitrate in accordance with the instruction. In contrast, FLUS-MaxRequestbitrate (<FLUS-Maxbitrate) is given to the source side as hint information of the sink side. In this case, it depends on the selection of the source side which value greater than or equal to FLUS-MaxRequestbitrate and less than or equal to FLUS-Maxbitrate is used.

With reference to FIG. 33, a distribution system according to the third embodiment is described. FIG. 33 illustrates the distribution system according to the third embodiment. Here, FIG. 33 illustrates only the one imaging device 10-1 for the sake of explanation, but a distribution system 1C includes a plurality of imaging devices.

In the distribution system 1C, for example, respective users viewing and listening to video streams desire different bit rate values. Accordingly, the distribution system 1C acquires the maximum bit rate value of a video stream desired by a user viewing and listening to the video stream, for example, from the user.

Specifically, the relay node 30-3 compares requests from the user terminals 40-1 to 40-3 to acquire segments of the same video stream at the same time slot that the respective users view and listen to. The relay node 30-3 determines the segment request having the maximum bit rate of them as the maximum request bit rate in the session. FIG. 33 illustrates the flow of MPE-MaXRequestBitrate by a chain line. The relay node 30-4 compares requests from the user terminals 40-4 and 40-5 to acquire segments of the same video stream at the same time slot that the respective users view and listen to. The relay node 30-4 generates MPE-MaXRequestBitrate with the segment request having the maximum bit rate of them as the maximum request bit rate in the session. The relay node 30-5 compares requests from the user terminals 40-6 and 40-7 to acquire segments of the same video stream at the same time slot that the respective users view and listen to. The relay node 30-5 generates MPE-MaXRequestBitrate with the segment request having the maximum bit rate of them as the maximum request bit rate in the session.

The relay node 30-3 and the relay node 30-4 each transfer generated MPE-MaXRequestBitrate to the relay node 30-1. The relay node 30-5 transfers generated MPE-MaXRequestBitrate to the relay node 30-2.

The relay node 30-1 transfers MPE-MaXRequestBitrate received from the relay node 30-3 and the relay node 30-4 to the distribution device 20. The relay node 30-2 transfers the request received from the relay node 30-5 to the distribution device 20.

The distribution device 20 outputs MPE-MaXRequestBitrate received from the relay node 30-1 and the relay node 30-2 to the imaging device 10-1 as FLUS-MaXRequestBitrate.

The imaging device 10-1 updates the maximum bit rate value of the high image quality video stream 82-1 on the basis of the received request. This processing is described below.

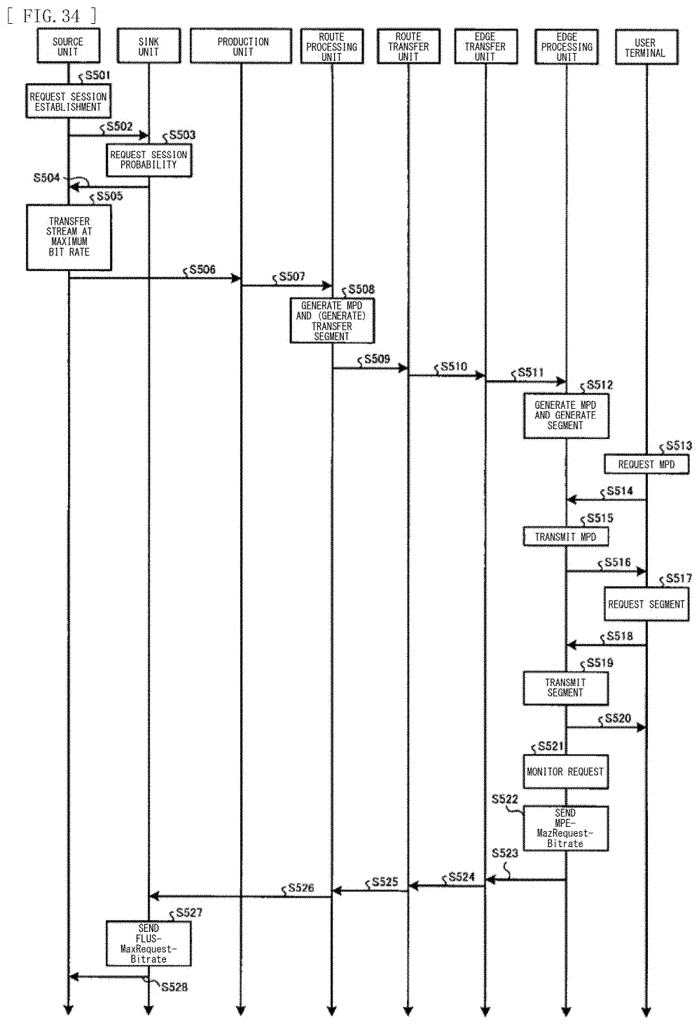

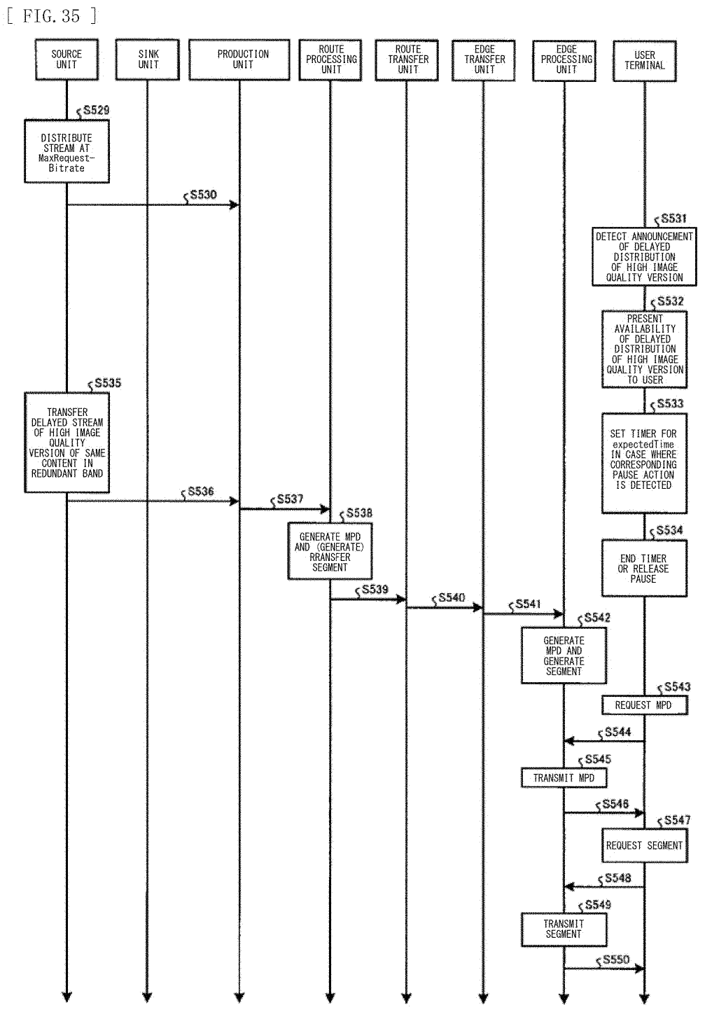

With reference FIGS. 34 and 35, an example of a processing flow of the distribution system 1C according to the third embodiment is described. Each of FIGS. 34 and 35 is a flowchart illustrating an example of a processing flow of the distribution system 1C according to the third embodiment. It is to be noted that description is given in FIGS. 34 and 35 by assuming that a multicast tree is configured in the method illustrated in FIG. 6.

Step S501 to step S504 and step S501A to step S504A are the same as step S401 to step S404 and step S401A to step S404A illustrated in FIG. 31 and description is thus omitted.

After step S504, the source unit 11 transmits a video stream to the production unit 24 at the maximum bit rate value about which the source unit 11 has been instructed (step S505 and step S506). It is to be noted here that it is assumed that the source unit 11 has received FLUS-MaxBitrate described above from the sink unit 12 in advance as a FLUS message. For example, the source unit 11 performs transmission at 2000 (bps) as the maximum value of a bit rate value.

Step S507 to step S520 are similar to step S407 to step S420 and description is thus omitted.

After step S512, the edge processing unit 31 monitors the maximum value of a bit rate value of a request (segment request group exchanged in step S518) of a segment request of a video stream desired by a user from the user terminal 40 (step S521).

The edge processing unit 31 outputs the acquired maximum value of the bit rate value to the edge transfer unit 32 as “MPE-MaxRequestBitrate” (step S522 and step S523).

The edge transfer unit 32 transfers “MPE-MaxRequestBitrate” to the route transfer unit 23 (step S524). The route transfer unit 23 transfers “MPE-MaxRequestBitrate” to the route processing unit 22 (step S525). The route processing unit 22 transfers “MPE-MaxRequestBitrate” to the sink unit 12 (step S526).

The sink unit 12 performs predetermined processing on received “MPE-MaxRequestBitrate” to generate “FLUS-MaxRequestBitrate” and transfers “FLUS-MaxRequestBitrate” to the source unit 11 (step S527 and step S528).

With reference to FIG. 35, the processing subsequent to FIG. 34 is described.

The source unit 11 changes the bit rate value in accordance with received “FLUS-MaxRequestBitrate” and transmits a video stream to the sink unit 21 (step S529 and step S530).

Specific processing from step S527 to step S530 is described. In step S527 to step S530, the sink unit 12 generates MPD and notifies the source unit 11 thereof. The source unit 11 generates a segment on the basis of the MPD received from the sink unit 12 and transfers the segment to the FLUS sink side. In this case, it is possible to seamlessly switch video streams over the plurality of source units 11. Here, the sink unit 12 is able to set a bit rate value greater than or equal to “FLUS-MaxRequestBitrate” in MPD in step S528 and step S529 if the time interval of the segment is not violated.

Step S531 to step S551 are similar to step S421 to step S440 in FIG. 31 and description is thus omitted.

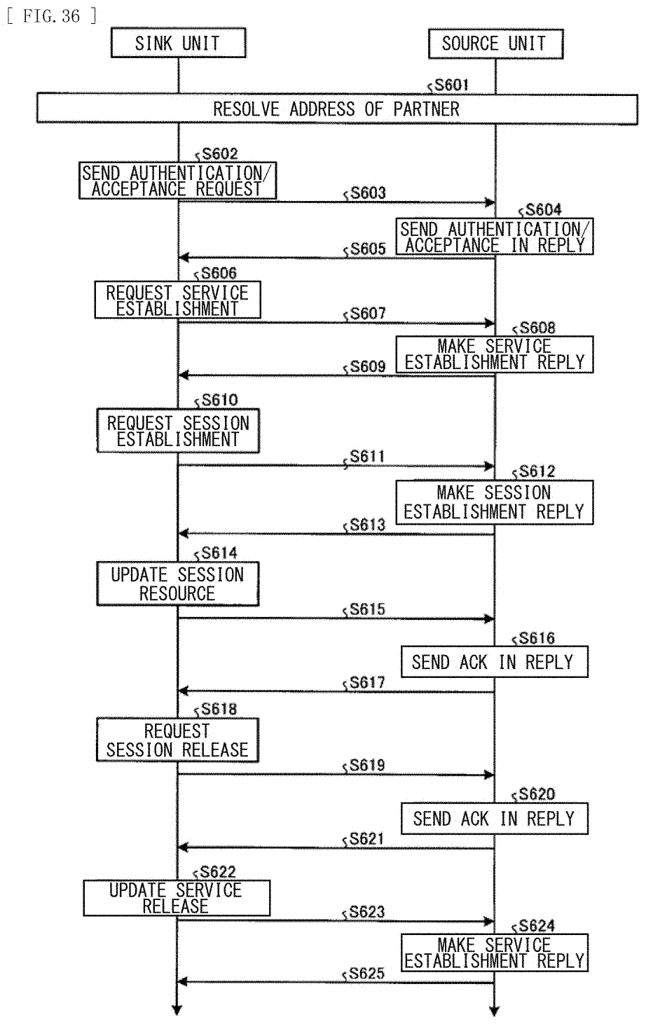

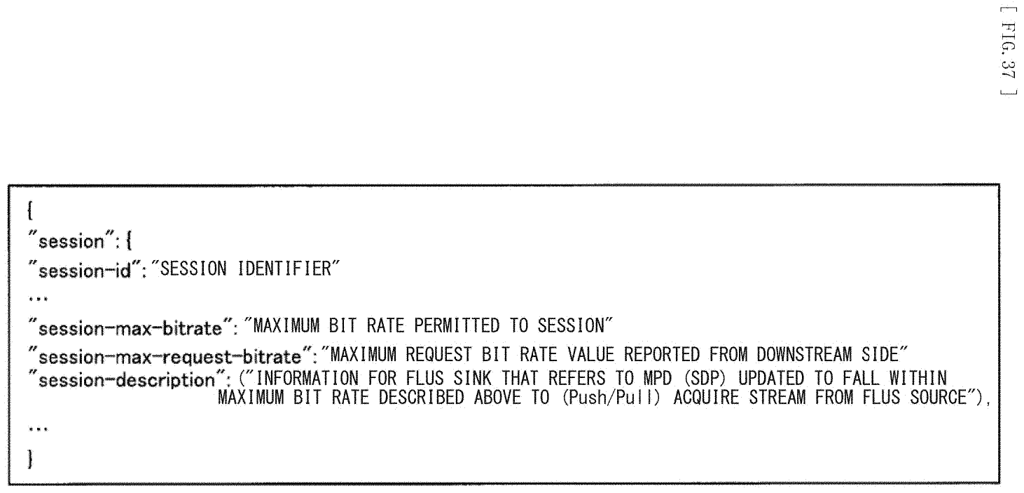

Next, with reference to FIG. 36, a method is described of establishing a session between the sink unit 12 and the source unit 11 according to the third embodiment. FIG. 36 is a sequence diagram illustrating a processing flow between the sink unit 12 and the source unit 11.

First, the sink unit 12 and the source unit 11 execute address resolution of a partner (step S601).

Step S602 to step S613 are different from step S301 to step S312 illustrated in FIG. 13 only in that it is not the source unit 11 but the sink unit 12 that transfers a request or the like. The other points are similar and description is thus omitted.

Next, the sink unit 12 transmits updated “SessionResource” to the source unit 11 (step S614 and step S615). Specifically, the sink unit 12 adds “FLUS-MaxRequestBitrate” to “SessionResource” to update “session-description”. The sink unit 12 then issues a notification of updated “SessionResource” by PUT of the HTTP methods.

FIG. 37 is a diagram illustrating an example of “SessionResource” updated by the sink unit 12. “session-max-bitrate” is “FLUS-MaxRequestBitrate” added in step S614 and step S615. “session-max-request-bitrate” is the maximum bit rate value of a request bit rate sent from the downstream side. “session-description” stores what is the same as “session-description” updated in step S614 and step S615. It is to be noted that, as a message between FLUSes, a maximum bit rate is introduced as “session-max-request-bitrate”, but this is an example. This does not limit the present disclosure. The present disclosure may extend, for example, MPD itself to issue a notification of a maximum bit rate value.

Upon receiving updated “SessionResource”, the source unit 11 then sends ACK to the sink unit 12 in reply (step S616 and step S617). The ACK is an affirmative reply indicating that data is received. Specifically, in a case where a session results in success, the source unit 11 transmits HTTP 200 OK to the sink unit 12 as an HTTP status code. In this case, the URL of updated “SessionResource” is described in the HTTP Location header.

Step S618 to step S625 are similar to step S325 to step S332 illustrated in FIG. 14 and description is thus omitted.

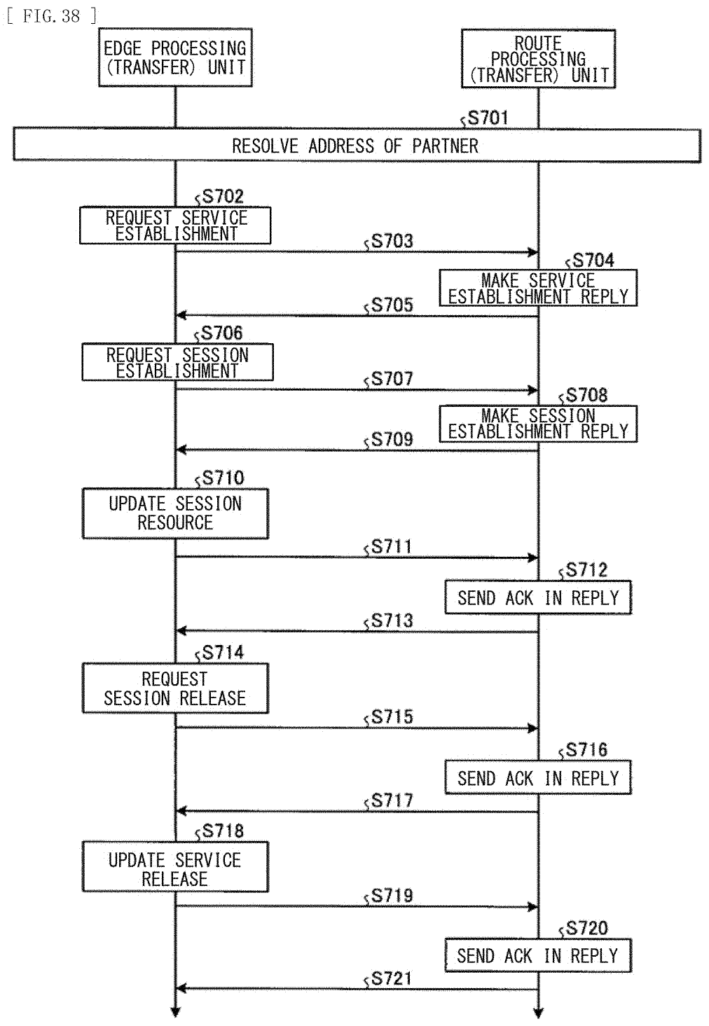

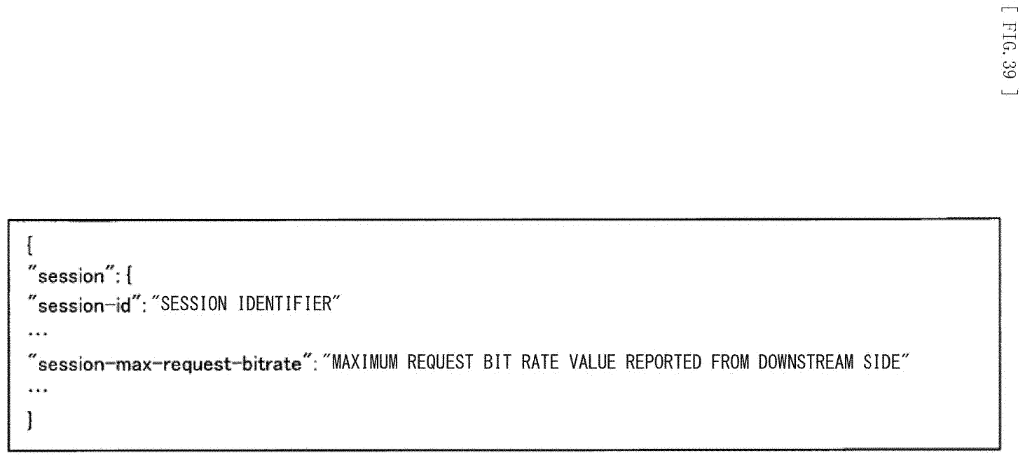

Next, with reference to FIG. 38, a method is described of establishing a session between the edge processing unit 31 and the route processing unit 22 according to the third embodiment. FIG. 38 is a sequence diagram illustrating a processing flow between the edge processing unit 31 and the route processing unit 22. In other words, FIG. 38 illustrates a processing flow between downstream MPE and upstream MPE. It is to be noted that processing between the edge processing unit 31 and the route processing unit 22 is executed via the edge transfer unit 32 and the route transfer unit 23 in FIG. 38.

First, the edge processing unit 31 and the route processing unit 22 execute address resolution of a partner (step S701). Specifically, the route is resolved by going back in a multicast tree from the edge processing unit 31 to the route processing unit 22.

The edge processing unit 31 transmits a service establishment request to the route processing unit 22 (step S702 and step S703). Specifically, the edge processing unit 31 requests a service to be established by POST of the HTTP methods. Here, the body of the POST communication is named as “ServiceResource”.

Upon receiving a service establishment request, the route processing unit 22 then transmits a reply of service establishment to the edge processing unit 31 (step S704 and step S705). Specifically, the route processing unit 22 transmits HTTP 201 CREATED to the edge processing unit 31 as an HTTP status code. This describes the URL of “ServiceResource” updated by the route processing unit 22 in the HTTP Location header. In a case where the service establishment results in success, a predetermined value is stored in “service-id” of “ServiceResource” generated by the route processing unit 22.

Next, the edge processing unit 31 transmits a session establishment request to the route processing unit 22 (step S706 and step S707). Specifically, the edge processing unit 31 requests a session to be established by POST of the HTTP methods. Here, the body of the POST communication is named as “SessionResource”.

Upon receiving a session establishment request, the route processing unit 22 then transmits a reply of session establishment to the edge processing unit 31 (step S708 and step S709). Specifically, the route processing unit 22 transmits HTTP 201 CREATED to the edge processing unit 31 as an HTTP status code. This describes the URL of “SessionResource” updated by the route processing unit 22 in the HTTP Location header. In a case where the service establishment results in success, a predetermined value is stored in “session-id” of “ServiceResource” generated by the route processing unit 22.

Next, the edge processing unit 31 transmits updated “SessionResource” to the route processing unit 22 (step S710 and step S711). Specifically, the edge processing unit 31 adds “FLUS-MaxRequestBitrate” to “SessionResource”. The edge processing unit 31 then issues a notification of updated “SessionResource” by PUT of the HTTP methods.

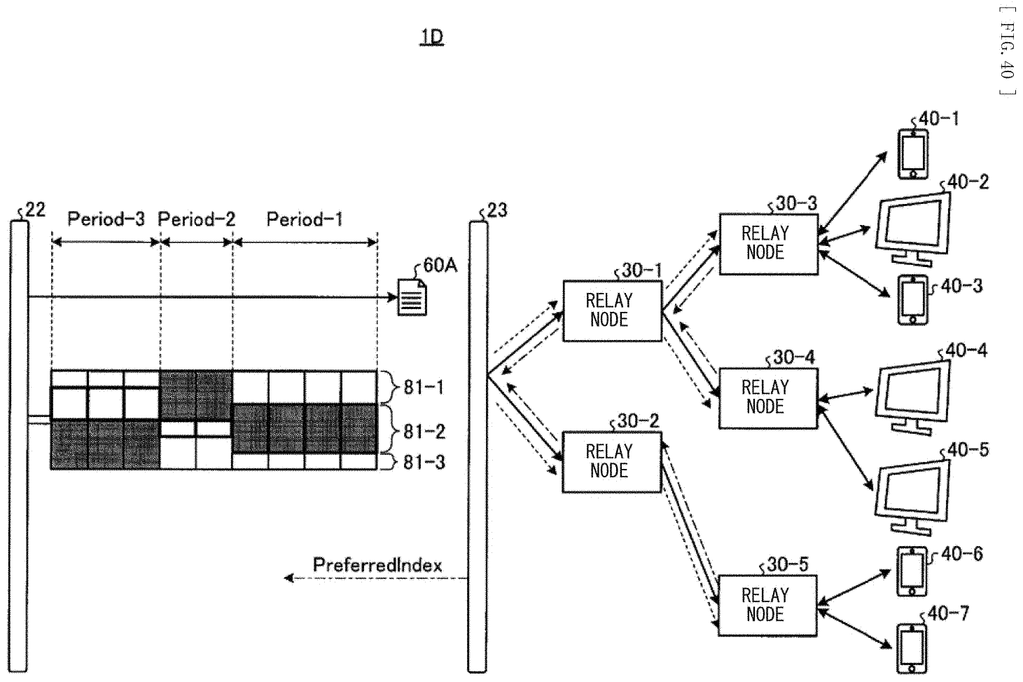

FIG. 39 is a diagram illustrating an example of “SessionResource” updated by the edge processing unit 31. “session-max-request-bitrate” is the maximum bit rate value of a request bit rate requested by a user and sent from the downstream side. Here, “session-max-request-bitrate” means FLUS-MaxRequestBitrate described above.

Upon receiving updated “SessionResource”, the route processing unit 22 then sends ACK to the edge processing unit 31 in reply (step S712 and step S713). The ACK is an affirmative reply indicating that data is received. Specifically, in a case where a session results in success, the route processing unit 22 transmits HTTP 200 OK to the edge processing unit 31 as an HTTP status code. In this case, the URL of updated “SessionResource” is described in the HTTP Location header.

Next, the edge processing unit 31 notifies the route processing unit 22 of a session release request (step S714 and step S715). Specifically, the edge processing unit 31 notifies the route processing unit 22 of the URL of corresponding “SessionResource” by DELETE of the HTTP methods.

Upon receiving the session release result, the route processing unit 22 then sends ACK to the edge processing unit 31 in reply (step S716 and step S717). The ACK is an affirmative reply indicating that data is received. Specifically, the route processing unit 22 transmits HTTP 200 OK to the edge processing unit 31 as an HTTP status code. In this case, the URL of released “SessionResource” is described in the HTTP Location header.

Next, the edge processing unit 31 notifies the route processing unit 22 of a service release request (step S718 and step S719). Specifically, the edge processing unit 31 notifies the route processing unit 22 of the URL of corresponding “ServiceResource” by DELETE of the HTTP methods.

Upon receiving the service release result, the route processing unit 22 then sends ACK to the edge processing unit 31 in reply (step S720 and step S721). The ACK is an affirmative reply indicating that data is received. Specifically, the route processing unit 22 transmits HTTP 2000K to the source control section 11b as an HTTP status code. The URL of released “ServiceResource” is described in the HTTP Location header. The established session then ends.

As described above, in the third embodiment, a notification of the maximum bit rate value desired by a user for a video stream is issued. This makes it possible to prevent a video stream from having too high a bit rate value. As a result, in a case where there is a redundant band for transferring a stream from each of sources, it is possible to effectively use the redundant band.

### 4. Fourth Embodiment

Cases are assumed where it is desired in the first embodiment that camera streams (further individual camerawork) be selected that match moment-to-moment viewing and listening preferences of a variety of users. For example, it is assumed that video having a popular player of a team with everyone is preferentially selected and streamed in a case where a user is viewing and listening to sports broadcast such as soccer broadcast.

There is, however, a problem that it is not possible to provide various types of indexes for streams that are interpretable in common to clients coming from different vendors. In the current MPD, it is not possible to designate an index (set of keywords/vocabulary that a sender side is able to designate) using a free word for a target/contents included in video having certain “AdaptationSet”. In other words, it is not possible to freely express a target/contents appearing in a certain video section. If it is possible to define such an index in MPD, it is possible to have a target/contents of the stream be known to a user on a user interface. As a result, it is possible to use an index as a guideline to select a stream. In addition, it is possible to collect the values of indexes defined by those sender sides in real time and use the frequency of a selected index as the interest level of each stream (such as an angle).

Although specifically described below, “TargetIndex” that is an index serving as an instruction from a sink side is introduced to “AdaptationSet” of MPD and this makes it possible to explicitly indicate that a stream is imaged/captured on the basis of a guideline of certain contents. Here, the certain contents are not particularly limited. A target, an item, or the like may be freely set. This makes it possible to group “AdaptationSet's” into a class of a certain preference and efficiently perform reproduction desired by a user. The confirmation of “TargetIndex” allows a viewer and listener to confirm from what viewpoint (target or item) “AdaptationSet” has been shot.

For example, “TrgetIndex/SchemeIdUri&value” is defined and vocabulary designation is then performed that indicates a certain team name or player name. In this case, “AdaptationSet” thereof indicates that the team member designated there or a specific player frequently appears.

For example, it is possible to provide one “AdaptationSet” with a plurality of “TargetIndex's”. In addition, in a case where a plurality of imaging devices has the same target, it is also possible to share the same “TargetIndex” between a plurality of “AdaptationSet's”.

TargetIndex depends on time. TargetIndex may be therefore updated by consecutively update MPD or achieved by generating a segment for the formation of a timeline.

Further, in the fourth embodiment, “MPE-PreferredIndex” is introduced as an MPE message for the edge transfer unit 32 to notify the route transfer unit 23 what “TargetIndex” a user group frequently views and listen to. This notifies the route transfer unit 23 of “TargetIndex” frequently requested by a user group moment to moment.

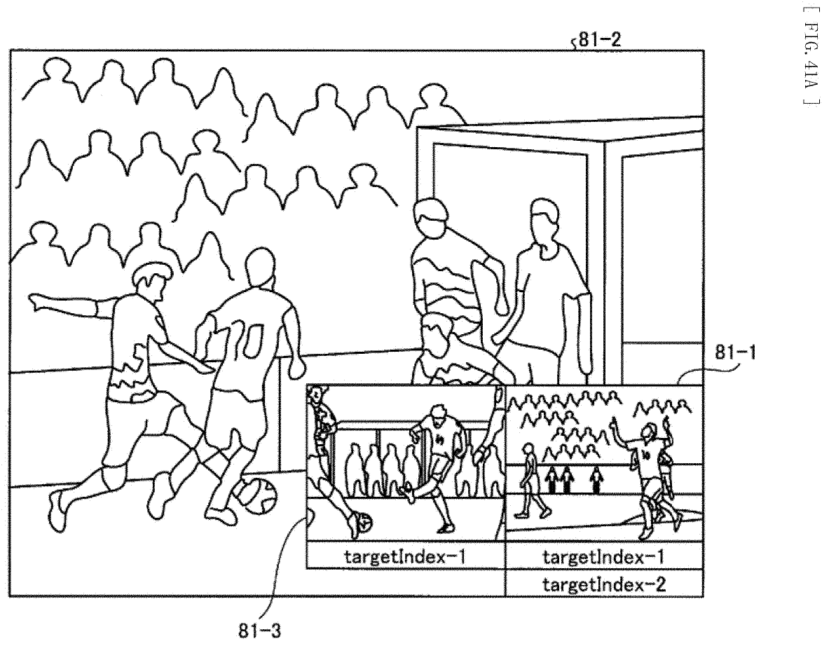

With reference to FIG. 40, a distribution system according to the fourth embodiment is described. FIG. 40 is a schematic diagram for describing the distribution system according to the fourth embodiment.

As illustrated in FIG. 40, description is given by assuming that the three video streams of the video stream 81-1, the video stream 81-2, and the video stream 81-3 are inputted to the route transfer unit 23. MPD 60A is inputted to the route transfer unit 23 from the route processing unit 22. “TargetIndex's” of the video streams 81-1 to 81-3 are described in the MPD 60A. “PreferredIndex's” acquired from the user terminals 40-1 to 40-7 are inputted to the route transfer unit 23. FIG. 40 illustrates the flow of “PreferredIndex” by a chain line.

The video stream 81-1 is a video stream inputted from the first FLUS source. It is indicated that the video stream 81-1 is ROI during Period-2. Here, it is assumed that “AdaptationSet” of the video stream 81-1 in the MPD 60A describes, for example, two TargetIndex's including targetIndex-1 and targetIndex-2.

The video stream 81-2 is a video stream inputted from the second FLUS source. It is indicated that the video stream 81-2 is ROI during Period-1. Here, it is assumed that “AdaptationSet” of the video stream 81-2 in the MPD 60A describes, for example, three TargetIndex's including targetIndex-1, targetIndex-2, and targetIndex-3.

The video stream 81-3 is a video stream inputted from the first FLUS source. It is indicated that the video stream 81-3 is ROI during Period-3. Here, it is assumed that “AdaptationSet” of the video stream 81-1 in the MPD 60A describes, for example, one TargetIndex including targetIndex-1.

In a fourth embodiment, for example, in a case where maximum bit rates are set for the respective sources included in a distribution system 1D, it is possible to allocate a large number of bit rates to the source including the most TargetIndex's among TargetIndex's that have been reported. In other words, in the fourth embodiment, it is possible to extract video corresponding to the taste of each of users and explicitly indicate the extracted video for the user.

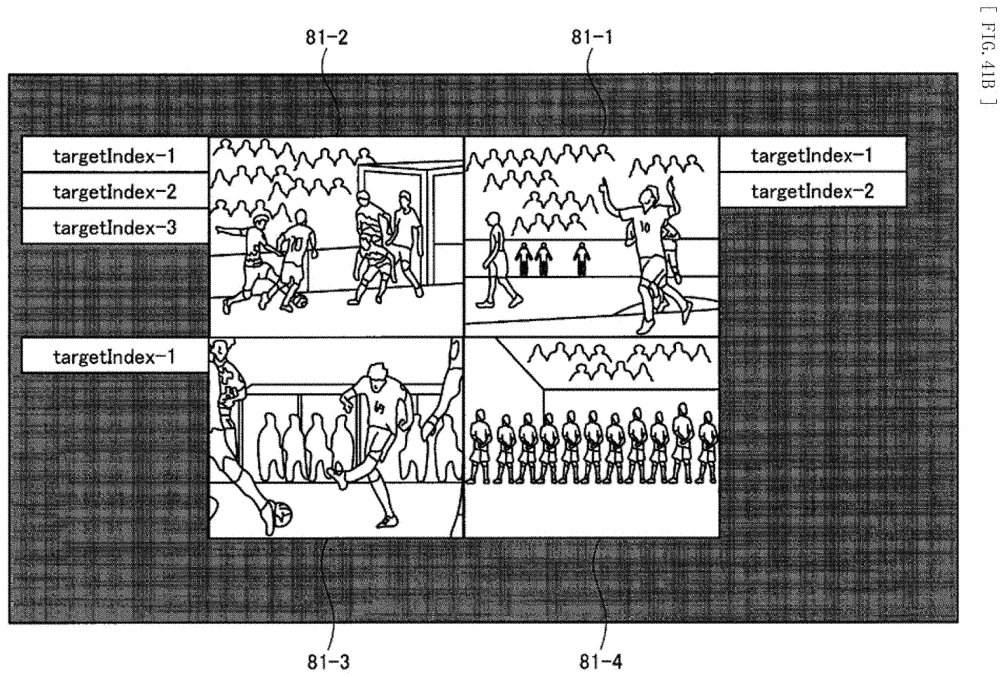

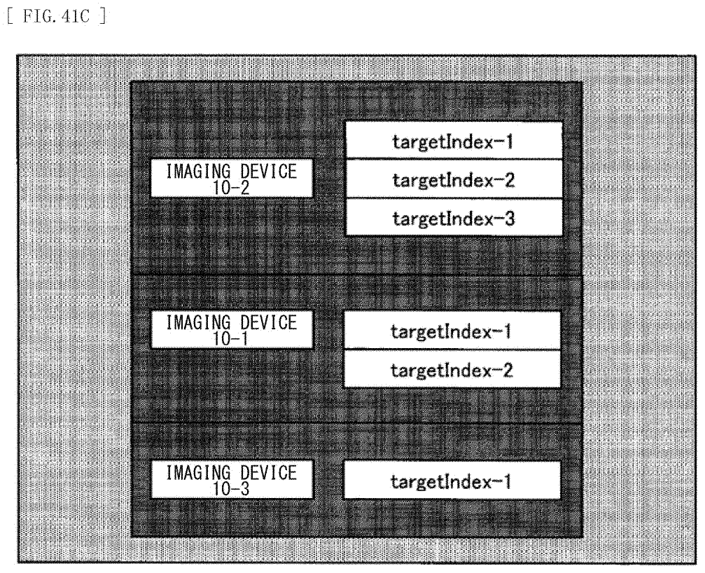

With reference to each of FIGS. 41A, 41B, and 41C, an example of a video stream achieved in the distribution system 1D is described. Each of FIGS. 41A, 41B, and 41C is a diagram illustrating an example of a video stream achieved in the distribution system 1D. It is assumed that each of FIGS. 41A, 41B, and 41C illustrates, for example, the video in the section of Period-1 illustrated in FIG. 40.

As illustrated in FIG. 41A, for example, the video of the video stream 81-2 that is ROI is enlarged and displayed and the video stream 81-1 and the video stream 81-3 are subjected to PinP (Picture in Picture) display. In this case, the screen may display TargetIndex's and cause a viewer and listener to confirm TargetIndex's provided to the video streams. This makes it possible to provide the video stream that is requested the most by the respective viewers and listeners.

In addition, as illustrated in FIG. 41B, each of video streams may be divided and displayed. In this case, the video stream 81-2 that is ROI may be displayed at a position such as the upper left of the screen where it is easy to visually recognize the video stream 81-2. For example, a video stream 81-4 provided with no TargetIndex may be then displayed on the lower right. In this case, TargetIndex provided to each of video streams may also be displayed.

In addition, as illustrated in FIG. 41C, TargetIndex's included in each of video streams may be displayed like text scrolling.

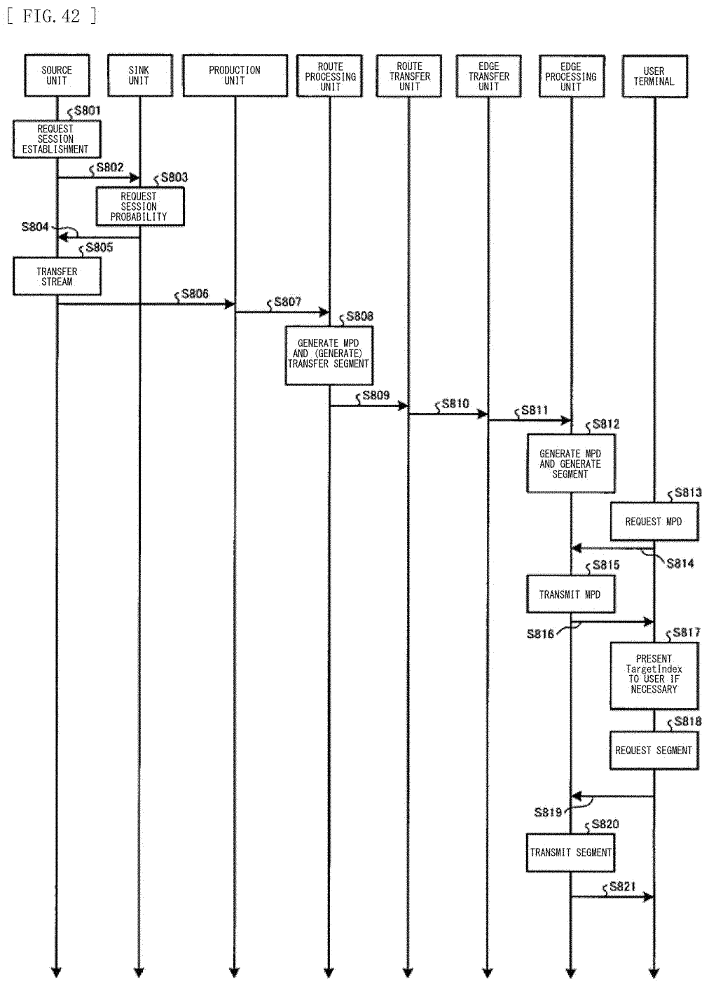

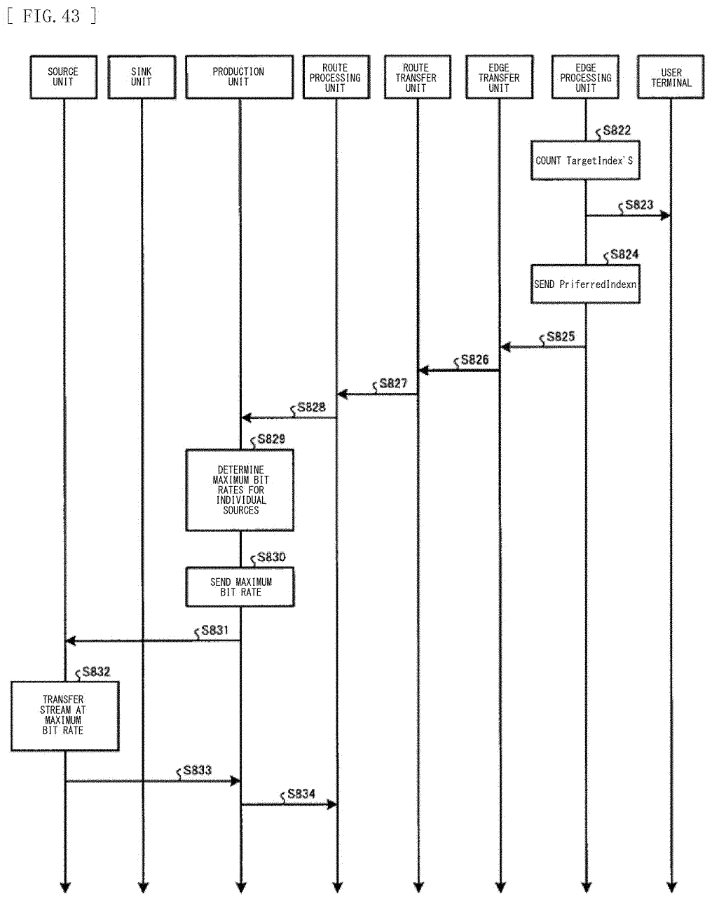

With reference FIGS. 42 and 43, an example of a processing flow of the distribution system 1D according to the fourth embodiment is described. Each of FIGS. 42 and 43 is a sequence diagram illustrating an example of the processing flow of the distribution system 1D according to the fourth embodiment. It is to be noted that description is given in FIGS. 42 and 43 by assuming that a multicast tree is configured in the method illustrated in FIG. 6.

Step S801 to step S804 are the same as step S201 to step S204 illustrated in FIG. 6 and description is thus omitted.

After step S804, the source unit 11 transmits a video stream to the production unit 24 at the maximum bit rate value about which the source unit 11 has been instructed (step S805 and step S806). Here, the production unit 24 generates MPD provided with TargetIndex.

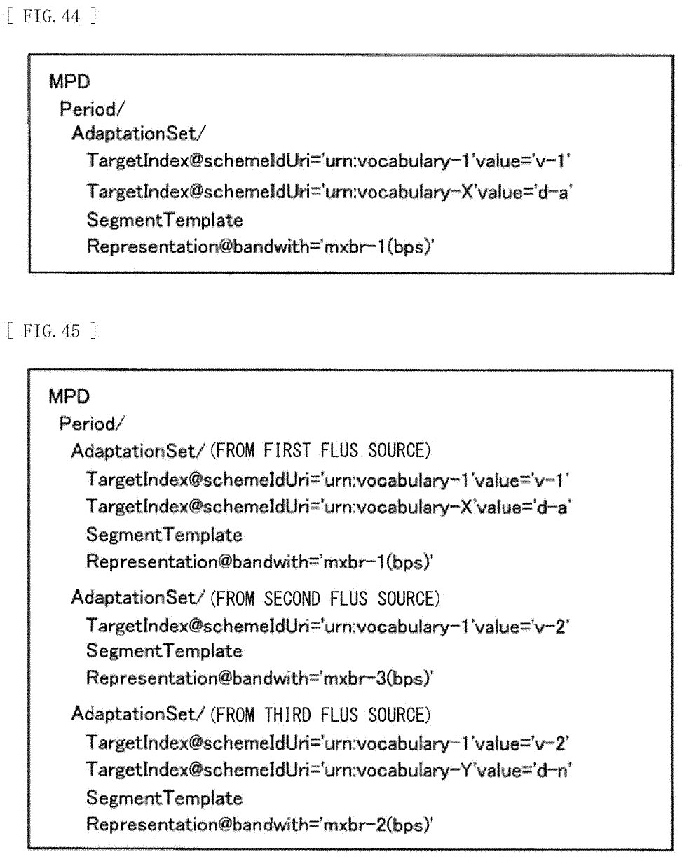

FIG. 44 is a schematic diagram illustrating an example of MPD generated by the production unit 24. As illustrated in FIG. 44, AdaptationSet is provided with two TargetIndex's. Specifically, “TargetIndex@schemeIdUri=‘urn:vocabulary-1’value=‘v-1’” and “TargetIndex@schemeIdUri=‘urn:dictionaly-X’ value=‘d-a’” are included. “‘urn:vocabulary-1’” indicates, for example, vocabulary designation. “value=‘v-1’” indicates specific contents such a team name and a player name. “‘urn:dictionaly-X’” indicates, for example, dictionary data. “value=‘d-a”’ indicates the contents of the dictionary data for identifying a team name and a player name.

The production unit 24 outputs the MPD of each source unit to the route processing unit 22 (step S807). It is assumed here that three MPDs are outputted to the route processing unit 22.

The route processing unit 22 generates one MPD on the basis of the three MPDs received from the production unit 24 and outputs the generated MPD to the route transfer unit 23 (step S808 and step S809).

FIG. 45 is a diagram illustrating an example of MPD generated by the route processing unit 22. AdaptationSet from the first FLUS source in the MPD illustrated in FIG. 45 includes two TargetIndex's. AdaptationSet from the second FLUS source includes one TargetIndex. TargetIndex from the third FLUS source includes two TargetIndex's.

Specifically, first “AdaptationSet” includes “TargetIndex@schemeIdUri=‘urn:vocabulary-1’value=‘v-1’” and “TargetIndex@sehemeIdUri=‘urn:dictionaly-X’ value=‘d-a’” as “Representation's”. In addition, “Representation” of first “AdaptationSet” includes “@bandwith=‘mxbr-1(bps)’”.

Second “AdaptationSet” includes “TargetIndex@schemeIdUri=‘urn:vocabulary-1’value=‘v-2’” as “Representation”. In other words, the second AdaptationSet does not include TargetIndex regarding a dictionary. In addition, in second “AdaptationSet”, “Representation” is “@bandwith=‘mxbr-3mxbr-3(bps)’”.

Specifically, third AdaptationSet includes “TargetIndex@schemeIdUri=‘urn:vocabulary-1’value=‘v-2’” and “TargetIndex@schemeIdUri=‘urn:dictionaly-Y’ value=‘d-n’” as “Representation's”. In other words, the third FLUS source and the second FLUS source perform vocabulary designation for the same contents. In such a case, it is possible to share TargetIndex regarding a dictionary between “AdaptationSet” of the second FLUS source and “AdaptationSet” of the third FLUS source. In addition, in third “AdaptationSet”, “Representation” is “@bandwith=‘mxbr-2(bps)’”.

The route transfer unit 23 transfers MPD generated by the route processing unit 22 to the edge transfer unit 32 (step S810). The edge transfer unit 32 outputs the MPD received from the route transfer unit 23 to the edge processing unit 31 (step S811).

The edge processing unit 31 generates new MPD on the basis of the MPD received from the edge transfer unit 32 (step S812).

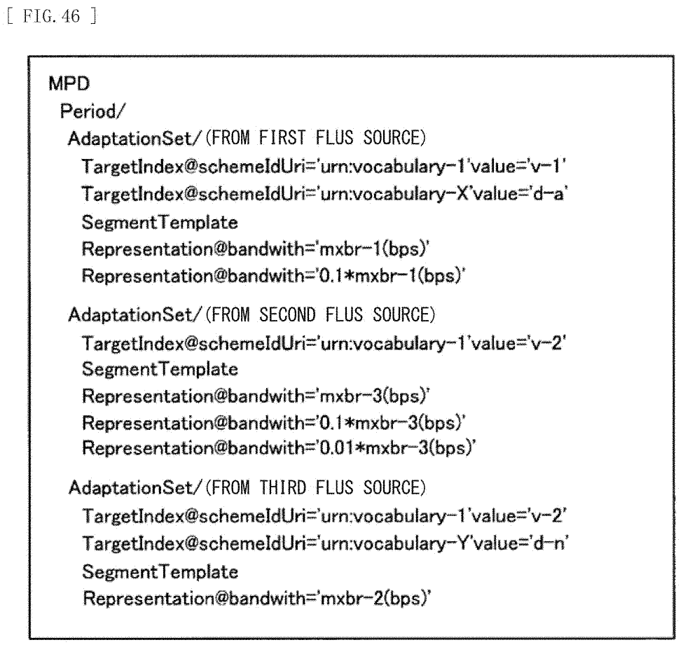

FIG. 46 is a diagram illustrating an example of MPD newly generated on the basis of MPD generated by the edge processing unit 31.

“Representation@bandwith=‘0.1mxbr-1(bps)’” is newly added to “AdaptationSet” of the first FLUS source.

“Representation@bandwith=‘0.1mxbr-3(bps)’” is newly added to “AdaptationSet” of the second FLUS source. In addition, “Representation@bandwith=‘0.01mxbr-3(bps)’” is added to “AdaptationSet” of the second FLUS source.

“AdaptationSet” of the third FLUS source has no change.

The user terminal 40 requests MPD from the edge processing unit 31 (step S813 and step S814). Upon receiving the request of MPD, the edge processing unit 31 sends MPD in reply (step S815 and step S816).

In a case where an operation of confirming TargetIndex is received from a user, the user terminal 40 displays TargetIndex in a video stream (step S817).

The user terminal 40 requests a segment from the edge processing unit 31 (step S818 and step S819). Upon receiving the request of a segment, the edge processing unit 31 sends a segment in reply (step S820 and step S821).

With reference to FIG. 43, the processing subsequent to FIG. 42 is described.

The edge processing unit 31 counts TargetIndex's associated with a segment requested by a user from the segment (step S822 and step S823).

The edge processing unit 31 outputs TargetIndex's associated with a segment requested by a user and the total number thereof to the edge transfer unit 32 from the segment as “MPE-PreferredIndex” (step S824 and S825).

The edge transfer unit 32 transfers “MPE-PreferredIndex” to the route transfer unit 23 (step S826). The route transfer unit 23 transfers “MPE-PreferredIndex” to the route processing unit 22 (step S827). The route processing unit 22 transfers “MPE-PreferredIndex” to the production unit 24 (step S828).

The production unit 24 determines maximum bit rate values for the individual source units 11 on the basis of “MPE-PreferredIndex” (step S829).

The production unit 24 transfers each of the maximum bit rate values determined in step S829 to the source unit 11 (step S830 and step S831).

The source unit 11 transfers a video stream to the production unit 24 in accordance with each the maximum bit rates received from the production unit 24 (step S832 and step S833). The production unit 24 outputs the video stream received from the source unit 11 to the route processing unit 22 (step S834). The following repeats the above-described processing.

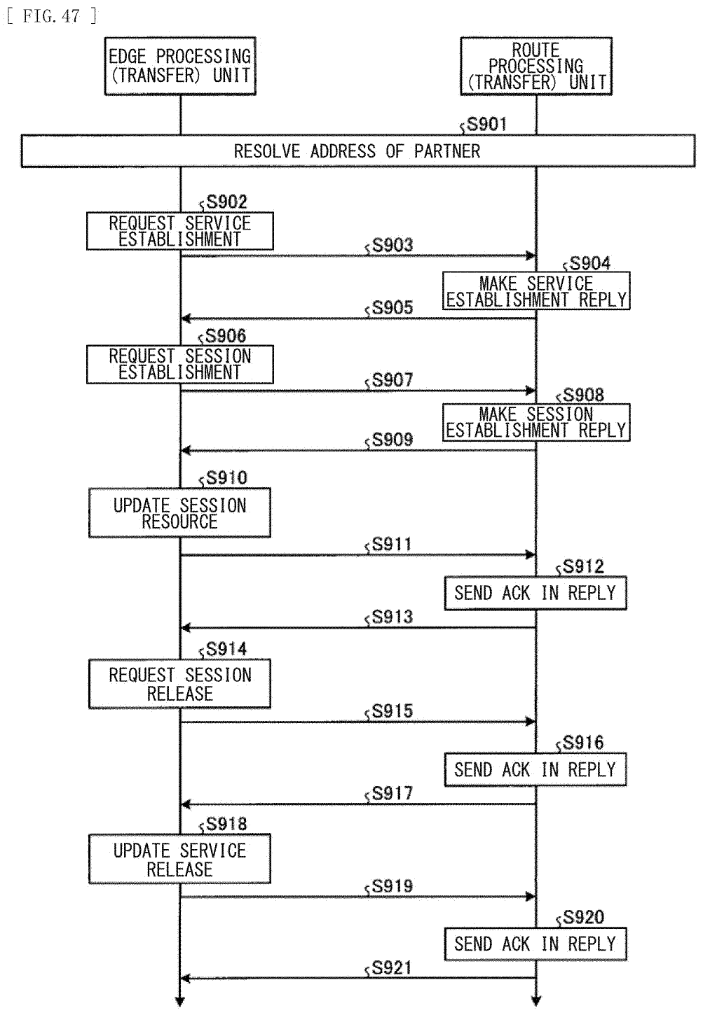

Next, with reference to FIG. 47, a method is described of establishing a session between the edge processing unit 31 and the route processing unit 22 according to the fourth embodiment.

Step S901 to step S909 are similar to step S701 to step S709 illustrated in FIG. 38 and description is thus omitted.

After step S909, the edge processing unit 31 transmits updated “SessionResource” to the route processing unit 22 (step S910 and step S911). Specifically, the edge processing unit 31 adds “PreferredIndex” to “SessionResource”. The edge processing unit 31 then issues a notification of updated “SessionResource” by PUT of the HTTP methods.

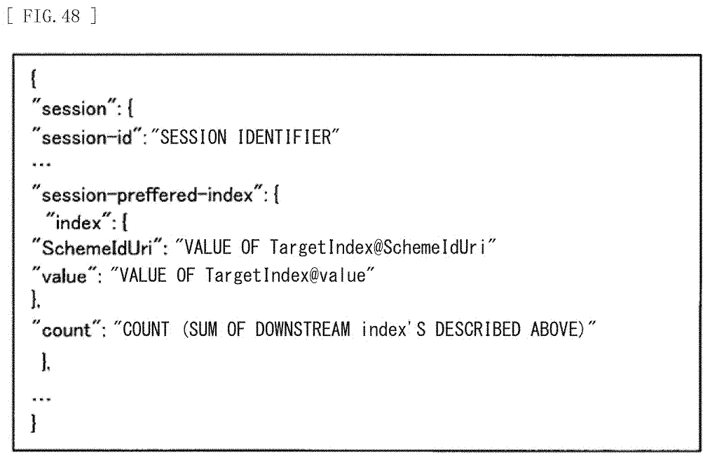

FIG. 48 is a diagram illustrating an example of “SessionResource” updated by the edge processing unit 31. “session-preferred-index” is the maximum bit rate value of a request bit rate requested by a user and sent from the downstream side. Here, “session-preferred-index” means MPE-PreferredIndex described above.

As illustrated in FIG. 48, “session-preferred-index” includes “SchemeIdUri” and “value” as “index's”. In addition, “session-preferred-index” includes “count”.

“SchemeIdUri” stores the “value of TargetIndex@SchemeIdUri”. This means that information (value) is stored for identifying the contents of a video stream.

“Value” stores the “value of TargetIndex@value”. In a video stream, this is information (value) for identifying information (e.g., specific athlete) designated by a user.

“count” stores “count (sum of downstream index's described above)”. This is the sum of “index's” acquired from the respective user terminals.

Step S912 to step S921 are similar to step S721 to step S721 illustrated in FIG. 38 and description is thus omitted.

As described above, in the fourth embodiment, the use of TartIndex and PrefferdIndex makes it possible to execute streaming in which the taste of each of users is reflected.

### 5. Hardware Configuration

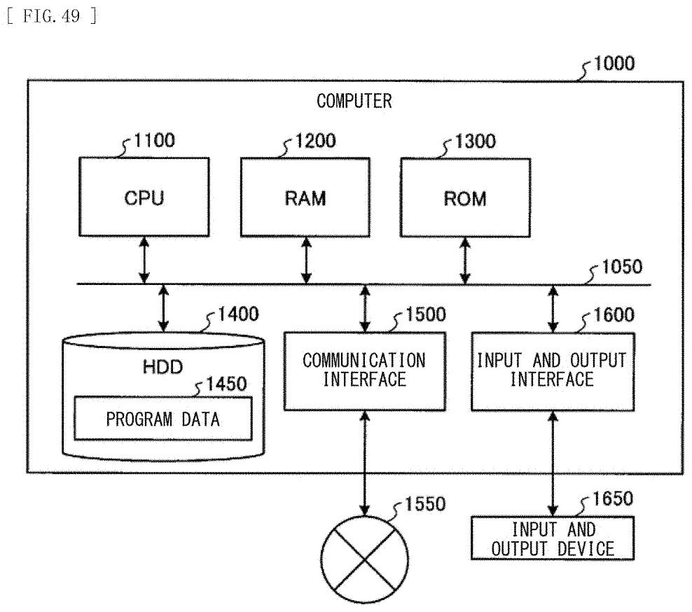

The imaging device and the information processing server according to the respective embodiments described above are achieved by a computer 1000 having, for example, a configuration as illustrated in FIG. 49. FIG. 49 is a hardware configuration diagram illustrating an example of the computer 1000 that achieves a function of the information processing server 100. The computer 1000 includes CPU 1100, RAM 1200, ROM (Read Only Memory) 1300, HDD (Hard Disk Drive) 1400, a communication interface 1500, and an input and output interface 1600. The respective units of the computer 1000 are coupled by a bus 1050.

The CPU 1100 comes into operation on the basis of a program stored in the ROM 1300 or the HDD 1400 and controls the respective units. For example, the CPU 1100 loads the program stored in the ROM 1300 or the HDD 1400 into the RAM 1200 to execute the processing corresponding to each type of program.

The ROM 1300 stores a boot program such as BIOS (Basic Input Output System) that is executed by the CPU 1100 to start the computer 1000, a program that is dependent on the hardware of the computer 1000, and the like.

The HDD 1400 is a computer-readable recording medium that has a program, data, and the like recorded thereon in a non-transitory manner. The program is executed by the CPU 1100. The data is used by the program. Specifically, the HDD 1400 is a recording medium having program data 1450 recorded thereon.

The communication interface 1500 is an interface for coupling the computer 1000 to an external network 1550 (e.g., the Internet). For example, the CPU 1100 receives data from another device and transmits data generated by the CPU 1100 to another device via the communication interface 1500.

The input and output interface 1600 is an interface for coupling an input and output device 1650 and the computer 1000. For example, the CPU 1100 receives data from an input device such as a keyboard or a mouse via the input and output interface 1600. In addition, the CPU 1100 transmits data to an output device such as a display, a speaker, or a printer via the input and output interface 1600. In addition, the input and output interface 1600 may also function as a media interface that reads out a program and the like recorded in a predetermined recording medium (media). Examples of the media include an optical recording medium such as DVD (Digital Versatile Disc) or PD (Phase change rewritable Disk), a magneto-optical recording medium such as MO (Magneto-Optical disk), a tape medium, a magnetic recording medium, a semiconductor memory, or the like.

For example, in a case where the computer 1000 functions as the information processing server 100, the CPU 1100 of the computer 1000 executes a program loaded into the RAM 1200 to achieve the functions of the respective units. It is to be noted that the CPU 1100 reads the program data 1450 from the HDD 1400 and then executes the program data 1450, but the CPU 1100 may acquire these programs from another device via the external network 1550 as another example.

It is to be noted that the effects described in the present specification are merely illustrative, but not limited. In addition, other effects may be included.

It is to be noted that the present technology is also able to adopt the following configurations.

(1)

A distribution system including:

a plurality of imaging devices having different specifications; and

an information processing server including a controller that generates first control information on the basis of a video stream uplinked from each of a plurality of the imaging devices, the first control information indicating a maximum bit rate value of the video stream, in which

the first control information includes information common to a plurality of the imaging devices.

(2)

The distribution system according to (1), in which the controller generates the first control information on the basis of information regarding an interest of a user in a plurality of the video streams.

(3)

The distribution system according to (1) or (2), including a clock unit that synchronizes operations of a plurality of the imaging devices.

(4)

The distribution system according to any of (1) to (3), in which segments of a plurality of the respective video streams uplinked by a plurality of the imaging devices have same length.

(5)

The distribution system according to any of (1) to (4), in which the first control information includes an MPD (Media Presentation Description) file.

(6)

The distribution system according to (5), in which the controller generates second Representation element on the basis of first Representation element, the first Representation element having a highest bit rate in AdaptationSet's of a plurality of the respective imaging devices, the AdaptationSet's being included in the MPD, the second Representation element having a lower bit rate than the bit rate of the first Representation element.

(7)

The distribution system according to (6), in which the bit rate of the second Representation element is determined by a request from a user.

(8)

The distribution system according to (1), in which, in a case where an uplink communication band is predicted to have a redundant band a predetermined period after the video stream is uplinked, the controller generates second control information indicating that it is going to be possible to view and listen to a high image quality version of the video stream after the predetermined period passes.

(9)

The distribution system according to (8), in which the second control information includes MPD.

(10)

The distribution system according to (8) or (9), in which the controller generates the second control information as an attribute of a Representation element of the video stream of a low image quality version in AdaptationSet, the AdaptationSet being included in the MPD.

(11)

The distribution system according to any of (8) to (10), in which the controller generates a Representation element having a lower bit rate than a bit rate of a Representation element of the video stream of a high image quality version on the basis of the Representation element of the video stream of the high image quality version.

(12)

The distribution system according to (1), in which the controller generates third control information for each of a plurality of the imaging devices, the third control information indicating a maximum bit rate value of the video stream corresponding to a request from a user.

(13)

The distribution system according to (12), in which the third control information is described in a body of HTTP (Hypertext Transport Protocol).

(14)

The distribution system according to (1), in which the controller extracts video data from a plurality of the video streams and generates fourth control information, the video data corresponding to taste of a user, the fourth control information causing a terminal of the user to explicitly indicate the extracted video data.

(15)

The distribution system according to (14), in which the controller displays an index along with the video data, the index being associated with the video data.

(16)

The distribution system according to (14) or (15), in which the fourth control information includes MPD.

(17)

The distribution system according to (16), in which the controller generates the fourth control information as a Representation element in AdaptationSet, the AdaptationSet being included in the MPD.

(18)

An information processing server including

a controller that generates first control information on the basis of a video stream uplinked from each of a plurality of imaging devices, the first control information indicating a maximum bit rate value of the video stream.

(19)

A distribution method including generating first control information on the basis of a video stream uplinked from each of a plurality of imaging devices, the first control information indicating a maximum bit rate value of the video stream.

### REFERENCE SIGNS LIST

10-1, 10-2, 10-3 imaging device
11-1 source unit
20 distribution device
21 sink unit
22 route processing unit
23 route transfer unit
24 production unit
30, 30-1, 30-2, 30-3, 30-4, 30-5 relay node
31 edge processing unit
32 edge transfer unit
40-1, 40-2, 40-3, 40-4, 40-5, 40-6, 40-7 user terminal
100 information processing server
110 clock unit
120 controller

1. A distribution system comprising:
a plurality of imaging devices having different specifications; and
an information processing server including a controller that generates first control information on a basis of a video stream uplinked from each of a plurality of the imaging devices, the first control information indicating a maximum bit rate value of the video stream, wherein
the first control information includes information common to a plurality of the imaging devices.

2. The distribution system according to claim 1, wherein the controller generates the first control information on a basis of information regarding an interest of a user in a plurality of the video streams.

3. The distribution system according to claim 1, comprising a clock unit that synchronizes operations of a plurality of the imaging devices.

4. The distribution system according to claim 1, wherein segments of a plurality of the respective video streams uplinked by a plurality of the imaging devices have same length.

5. The distribution system according to claim 1, wherein the first control information includes an MPD (Media Presentation Description) file.

6. The distribution system according to claim 5, wherein the controller generates second Representation on a basis of first Representation, the first Representation having a highest bit rate in AdaptationSet's of a plurality of the respective imaging devices, the AdaptationSet's being included in the MPD, the second Representation having a lower bit rate than the bit rate of the first Representation.

7. The distribution system according to claim 6, wherein the bit rate of the second Representation is determined by a request from a user.

8. The distribution system according to claim 1, wherein, in a case where an uplink communication band is predicted to have a redundant band a predetermined period after the video stream is uplinked, the controller generates second control information indicating that it is going to be possible to view and listen to a high image quality version of the video stream after the predetermined period passes.

9. The distribution system according to claim 8, wherein the second control information includes MPD.

10. The distribution system according to claim 9, wherein the controller generates the second control information as an attribute of Representation of the video stream of a low image quality version in AdaptationSet, the AdaptationSet being included in the MPD.

11. The distribution system according to claim 10, wherein the controller generates Representation having a lower bit rate than a bit rate of Representation of the video stream of a high image quality version on a basis of a Representation element of the video stream of the high image quality version.

12. The distribution system according to claim 1, wherein the controller generates third control information for each of a plurality of the imaging devices, the third control information indicating a maximum bit rate value of the video stream corresponding to a request from a user.

13. The distribution system according to claim 12, wherein the third control information is described in a body of HTTP (Hypertext Transport Protocol).

14. The distribution system according to claim 1, wherein the controller extracts video data from a plurality of the video streams and generates fourth control information, the video data corresponding to taste of a user, the fourth control information causing a terminal of the user to explicitly indicate the extracted video data.

15. The distribution system according to claim 14, wherein the controller displays an index along with the video data, the index being associated with the video data.

16. The distribution system according to claim 14, wherein the fourth control information includes MPD.

17. The distribution system according to claim 16, wherein the controller generates the fourth control information as a Representation attribute in AdaptationSet, the AdaptationSet being included in the MPD.

18. An information processing server comprising
a controller that generates first control information on a basis of a video stream uplinked from each of a plurality of imaging devices, the first control information indicating a maximum bit rate value of the video stream.

19. A distribution method comprising
generating first control information on a basis of a video stream uplinked from each of a plurality of imaging devices, the first control information indicating a maximum bit rate value of the video stream.
